(19) United States
(12) Patent Application Publication
(10) Pub. No.: US 2013/0293789 A1
(43) Pub. Date: Nov. 7, 2013

(54) LIGHTING DEVICE, DISPLAY DEVICE, AND TELEVISION RECEIVING DEVICE

(71) Applicant: Tatsuro Kuroda, Osaka (JP)

(72) Inventor: Tatsuro Kuroda, Osaka (JP)

(73) Assignee: SHARP KABUSHIKI KAISHA, Osaka (JP)

(21) Appl. No.: 13/979,069

(22) PCT Filed: Jan. 6, 2012
(86) PCT No.: PCT/JP2012/050169

§ 371 Date: Jul. 10, 2013

(30) Foreign Application Priority Data
Jan. 14, 2011 (JP) 2011-006166
Jan. 14, 2011 (JP) 2011-006170

(51) Int. Cl. F21V 15/01; G02F 1/1335

(52) U.S. Cl. CPC F21V 15/01; G02F 1/133608
USPC 348/790; 362/97.1; 362/97.2; 348/739

(57) ABSTRACT

An illumination device according to the present invention is provided with a control substrate 40 mounted on a chassis 14 and a substrate cover 60 that is arranged to cover the control substrate 40, and the substrate cover 60 and the chassis 14 are formed of a conductive material. The substrate cover 60 includes attaching parts 64 attached to the chassis 14 and a plurality of contact pieces 70 that come into contact with the chassis 14. First contact pieces 70A that are arranged from among the plurality of contact pieces 70 at positions comparatively distant from the attaching parts 64 of the substrate cover 60 are configured to bend along the thickness direction with greater ease than second contact pieces 70B that are arranged from among the plurality of contact pieces 70 at positions comparatively near to the attaching parts 64 of the substrate cover 60.

### TECHNICAL FIELD

The present invention relates to an illumination device, a display device, and a television receiver.

### BACKGROUND ART

Conventionally, liquid crystal panels used in liquid crystal display devices such as liquid crystal televisions do not emit light on their own, and thus, a backlight device is separately provided as an illumination device. Such backlight devices that are disposed on the rear side of the liquid crystal panel (side opposite to the display side) are known, and include a chassis that is open on the liquid crystal panel side, a plurality of light sources (cold cathode tubes, LEDs, or the like, for example) disposed on the inner side of the bottom plate of the chassis, optical members (diffusion plate and the like) disposed at the opening of the chassis and outputting light emitted from the light sources towards the liquid crystal panel side efficiently, and a light reflective sheet for reflecting light and the like from the light sources towards the optical members and the liquid crystal panel, disposed inside the chassis.

Chassis to which circuit boards for driving the liquid crystal display device are attached, and on which substrate covers are attached covering the circuit boards are known. One known example of a liquid crystal display device provided with such substrate covers is that disclosed in Patent Document 1 below.

When such circuit boards (circuit parts) are driven, there is a possibility that electromagnetic waves resulting from harmonics and the like of digital signals are released in the air, and there is a concern that such radiated electromagnetic waves would interfere with the operation of other electronic devices (EMI).

As a configuration to mitigate the release of such electromagnetic waves, a configuration is known in which the substrate covers and the chassis are made of a conductive material, and the substrate covers and the chassis are electrically connected to each other. With this configuration, the substrate covers and the chassis can effectively shield the circuit boards such that electromagnetic waves do not escape.

By electrically connecting the substrate covers and the chassis, electrical energy resulting from the electromagnetic waves is transmitted to the chassis through the substrate cover, thus being dissipated with greater ease. As a result, it is possible to mitigate a situation in which the substrate cover acts as an antenna (a situation in which electromagnetic waves are emitted through the substrate cover) as a result of the electromagnetic waves generated by the circuit board, thus preventing EMI more effectively.

The substrate cover and the chassis described above are connected electrically via a conductive member (gasket) that is typically elastic. The substrate cover and the chassis are bonded to each other via the gasket, thus electrically connecting the substrate cover to the chassis.

### RELATED ART DOCUMENT

### Patent Document

Patent Document 1: Japanese Patent Application Laid-Open Publication No. 2005-197510

### PROBLEMS TO BE SOLVED BY THE INVENTION

However, if a gasket is used to electrically connect the substrate cover and the chassis, it is necessary to have an extra step of adding the gasket, which decreases productivity. Also, the elasticity of the gasket sometimes decreases due to degradation from aging, which reduces the bonding strength of the gasket to the substrate cover (and to the chassis). As a result, the substrate cover and the chassis would no longer be sufficiently connected to each other electrically, which can reduce the electromagnetic shielding effect of this configuration.

### SUMMARY OF THE INVENTION

The present invention was completed in view of the above-mentioned situation, and an object thereof is to provide an illumination device that can more reliably connect the chassis to the substrate cover electrically without the use of a conductive member such as a gasket. Another object of the present invention is to provide a display device and a television receiver that includes such an illumination device.

### MEANS FOR SOLVING THE PROBLEMS

In order to solve the above-mentioned problem, an illumination device according to the present invention includes: a light source; a chassis that stores the light source; a circuit board attached to the chassis; and a substrate cover attached to the chassis and disposed so as to cover the circuit board; wherein the substrate cover and the chassis are made of a conductive material, wherein the substrate cover has an attaching part attached to the chassis, and a plurality of contact pieces extending towards the chassis and in contact therewith, wherein the plurality of contact pieces have a plate shape and are in contact with the chassis while warping in a plate thickness direction, and wherein, where contact pieces disposed in a position relatively far from the attaching part of the substrate cover are first contact pieces among the plurality of contact pieces, and where contact pieces disposed relatively close to the attaching part of the substrate cover are second contact pieces among the plurality of contact pieces, the first contact pieces are more susceptible to warping in the plate thickness direction thereof than the second contact pieces.

In the present invention, the substrate cover and the chassis are made of a conductive material, and the substrate cover is electrically connected to the chassis through the contact pieces extending from the substrate cover and in contact with the chassis. With such a configuration, even if electromagnetic waves are emitted from the circuit board when driving the circuit board, it is possible to effectively block electromagnetic waves from escaping the substrate cover and the chassis, and thus, it is possible to mitigate a situation in which electromagnetic waves are emitted to the outside. It is possible to electrically connect the substrate cover to the chassis by using a simple configuration in which the contact pieces extend from the substrate cover, and thus, it is possible to improve productivity compared to a case in which a conductive member such as a gasket is used.

If the contact pieces are in contact (elastically) with the chassis while warping, the chassis is pressed by the contact pieces, which sometimes causes the chassis to move further away from the substrate cover. If the chassis warps, then the contact pressure between the contact pieces and the chassis decreases, and as a result, contact between the contact pieces and the chassis becomes inefficient, and thus, this situation is undesirable. In the configuration of the present invention, the attaching parts of the substrate cover are attached to the chassis. Thus, when the chassis is pressed by the contact pieces (substrate cover side), positions on the chassis further from the attaching parts (parts attached to the substrate cover) of the substrate cover are more susceptible to warping.

In the present invention, of the plurality of contact pieces, the first contact pieces, which are relatively far from the attaching parts (attaching positions), are more susceptible to warping than the second contact pieces, which are relatively close to the attaching parts. Thus, when comparing the pressure on the chassis from the first contact pieces to that of the second contact pieces, the pressure from the first contact pieces, which are relatively far from the attaching parts, is less than the pressure from the second contact pieces, which are relatively close to the attaching parts. As a result, it is possible to effectively mitigate warping in the chassis in positions pressed by the first contact pieces (positions that are more susceptible to warping than positions pressed by the second contact pieces), which allows the contact pieces to be more reliably in contact with the chassis. Thus, the substrate cover can be more reliably connected electrically to the chassis, which allows the electromagnetic shielding effect of the substrate cover and the chassis to be greater.

In the configuration above, the plurality of contact pieces can be disposed along an entire peripheral section of the substrate cover. By having the plurality of contact pieces disposed along the entire periphery of the substrate cover, when the contact pieces are in contact with the chassis while warping, the elastic force from the contact pieces can be balanced through the entire periphery of the substrate cover. As a result, the contact pressure of the respective contact pieces on the chassis can be made more even. As a result, the contact pieces can be more reliably in contact with the chassis.

A configuration can be used wherein the substrate cover has a main wall disposed so as to sandwich the circuit board between the chassis and the main wall, and side walls that rise towards the chassis from a periphery of the main wall, and wherein, of the plurality of contact pieces, at least one of the contact pieces extends from the main wall and constitutes a portion of the side walls.

Because the contact pieces of the present invention are in contact with the chassis while warping in the plate thickness direction, it is preferable that the contact pieces be susceptible to warping to a certain extent. If the contact pieces extend from the main wall, compared to a configuration in which the contact pieces extend from the side walls, for example, the contact pieces can be made more susceptible to warping in the plate thickness direction, and thus, the contact pieces can be formed with greater ease. As a result, it is possible to reduce the cost of forming the contact pieces.

A configuration can be used wherein the substrate cover has a main wall disposed so as to sandwich the circuit board between the chassis and the main wall, and side walls that rise towards the chassis from a periphery of the main wall, and wherein, of the plurality of contact pieces, at least one of the contact pieces extends from one of the side walls.

If the contact pieces extend from the side walls, compared to a case in which the contact pieces extend from the main wall, for example, the extension length of the contact pieces can be made small. As a result, it is possible to reduce the cost of forming the contact pieces.

A configuration can be used wherein, of the plurality of contact pieces, at least one of the contact pieces has a contact surface in contact with the chassis having a bent shape with a bend that protrudes towards the chassis.

If the contact surface in contact with the chassis has a bent shape with a bend towards the chassis, then when the contact surface is in contact with the chassis, the contact pieces are susceptible to deforming when pressed against the chassis. As a result, the contact surface can be in closer contact with the chassis, thus being more reliably in contact with the chassis.

A configuration can be used wherein, of the plurality of contact pieces, a tip of at least one of the contact pieces has a protrusion that protrudes towards the chassis, and wherein the protrusion is in contact with the chassis.

In the present invention, the protrusions of the contact pieces are in contact with the chassis. With this configuration, when forming the protrusions, it is possible to adjust the contact pressure on the chassis with ease by adjusting the height of the protrusions.

An extension length from the substrate cover can be greater for the first contact pieces than for the second contact pieces. If, of the plurality of contact pieces, the extension length of the first contact pieces disposed relatively far from the attaching parts (parts attached to the chassis) is greater than the extension length of the second contact pieces disposed relatively close to the attaching parts, then even if positions on the chassis relatively far from the attaching part (positions more susceptible to warping) warp, it is possible to have reliable contact between the first contact pieces and the chassis. Thus, the substrate cover can be more reliably connected electrically to the chassis, which allows the electromagnetic shielding effect of the substrate cover and the chassis to be greater. Such a configuration of the extension lengths of the contact pieces can be applied not only to the configuration in which the first contact pieces are more susceptible to warping than the second contact pieces, but also to a configuration in which the first contact pieces are equally susceptible to warping as the second contact pieces, or a configuration in which the second contact pieces are more susceptible to warping, for example.

In order to solve the above-mentioned problem, a display device according to the present invention includes: the above-mentioned illumination device; and a display panel that conducts display using light from the illumination device.

A liquid crystal panel is an example of the aforementioned display panel. As a liquid crystal display device, such a display device can be applied to various applications such as a television or the display of a personal computer, for example, and is particularly suitable for large screens.

Next, in order to solve the above-mentioned problem, a television receiver of the present invention includes the above-mentioned display device.

### EFFECTS OF THE INVENTION

According to the present invention, it is possible to provide an illumination device in which the chassis and the substrate cover can be more reliably connected electrically without the use of a conductive member such as a gasket. Also, according to the present invention, it is possible to provide a display device and a television receiver that includes such an illumination device.

### BRIEF DESCRIPTION OF THE DRAWINGS

FIG. 1 is an exploded perspective view that shows a schematic configuration of a television receiver according to Embodiment 1 of the present invention.

FIG. 2 is an exploded perspective view that shows a schematic configuration of a liquid crystal display device provided in the television receiver of FIG. 1.

FIG. 3 is a cross-sectional view that shows a configuration of the liquid crystal display device along the longer side direction.

FIG. 4 is a plan view of the rear surface of a backlight device included in the liquid crystal display device of FIG. 2.

FIG. 5 is a plan view of the backlight device of FIG. 4 in which substrate covers are attached thereto.

FIG. 6 is a magnified view of a substrate cover of FIG. 5.

FIG. 7 is a magnified perspective view of a corner of the substrate cover of FIG. 6.

FIG. 8 is a cross-sectional view of a substrate cover (along the line A-A of FIG. 6).

FIG. 9 is a cross-sectional view of a substrate cover (along the line B-B of FIG. 6).

FIG. 10 is a plan view of a substrate cover according to Embodiment 2 of the present invention.

FIG. 11 is a cross-sectional view of the substrate cover of Embodiment 2 of the present invention (along the line D-D of FIG. 10).

FIG. 12 is a cross-sectional view of a configuration of a substrate cover according to Embodiment 3 of the present invention along the shorter side direction.

FIG. 13 is an exploded perspective view that shows a schematic configuration of a television receiver according to Embodiment 4 of the present invention.

FIG. 14 is an exploded perspective view that shows a schematic configuration of a liquid crystal display device provided in the television receiver of FIG. 13.

FIG. 15 is a cross-sectional view of a configuration of a liquid crystal display device along the longer side direction.

FIG. 16 is a plan view of the rear surface of a backlight device included in the liquid crystal display device of FIG. 14.

FIG. 17 is a plan view of the backlight device of FIG. 16 in which substrate covers are attached thereto.

FIG. 18 is a magnified view of a substrate cover of FIG. 17.

FIG. 19 is a magnified perspective view of a corner of the substrate cover of FIG. 18.

FIG. 20 is a cross-sectional view of a substrate cover (along the line A-A of FIG. 6).

FIG. 21 is a cross-sectional view of a substrate cover removed from the chassis (along the line A-A of FIG. 18).

FIG. 22 is a cross-sectional view of a substrate cover (along the line B-B of FIG. 18).

FIG. 23 is a cross-sectional view of a substrate cover removed from the chassis (along the line B-B of FIG. 18).

FIG. 24 is a cross-sectional view that shows a situation in which the bottom plate of the chassis in FIG. 22 is warped.

FIG. 25 shows a comparison example.

FIG. 26 is a plan view of a substrate cover according to Embodiment 5 of the present invention.

FIG. 27 is a cross-sectional view of a substrate cover (along the line D-D of FIG. 26).

FIG. 28 is a side view of a substrate cover removed from the chassis (along the line E-E of FIG. 26).

FIG. 29 is a cross-sectional view of a substrate cover (along the line E-E of FIG. 26).

FIG. 30 is a side view of a substrate cover (removed from the chassis) according to Embodiment 6 of the present invention.

FIG. 31 is a side view of the substrate cover (attached to the chassis) according to Embodiment 6 of the present invention.

FIG. 32 is a magnified view of a first contact piece in FIG. 31.

FIG. 33 shows a comparison example.

FIG. 34 shows another embodiment.

### DETAILED DESCRIPTION OF EMBODIMENTS

### Embodiment 1

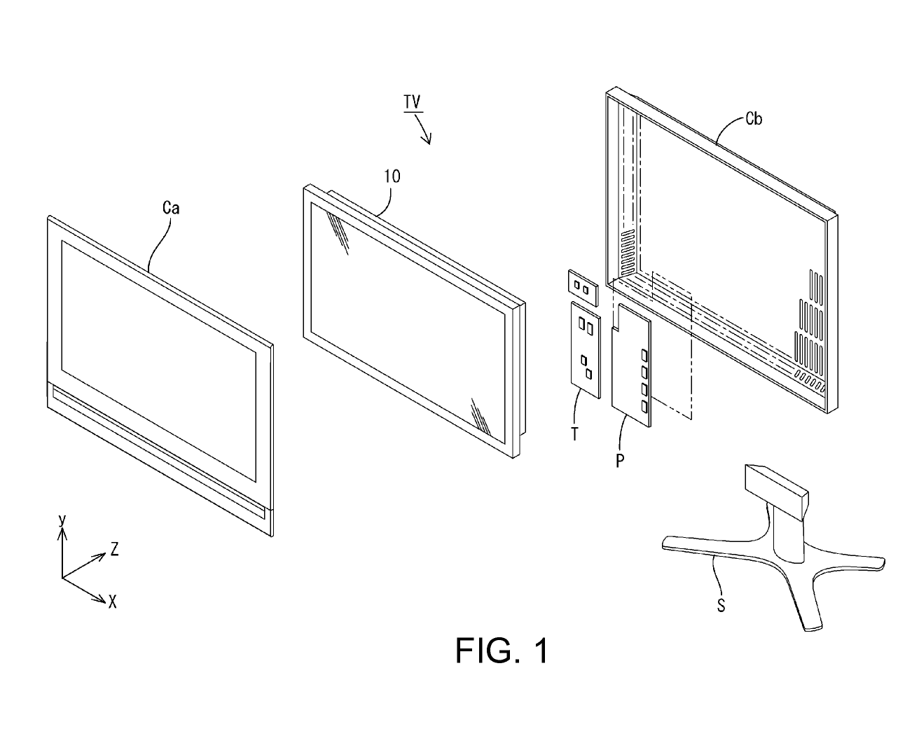

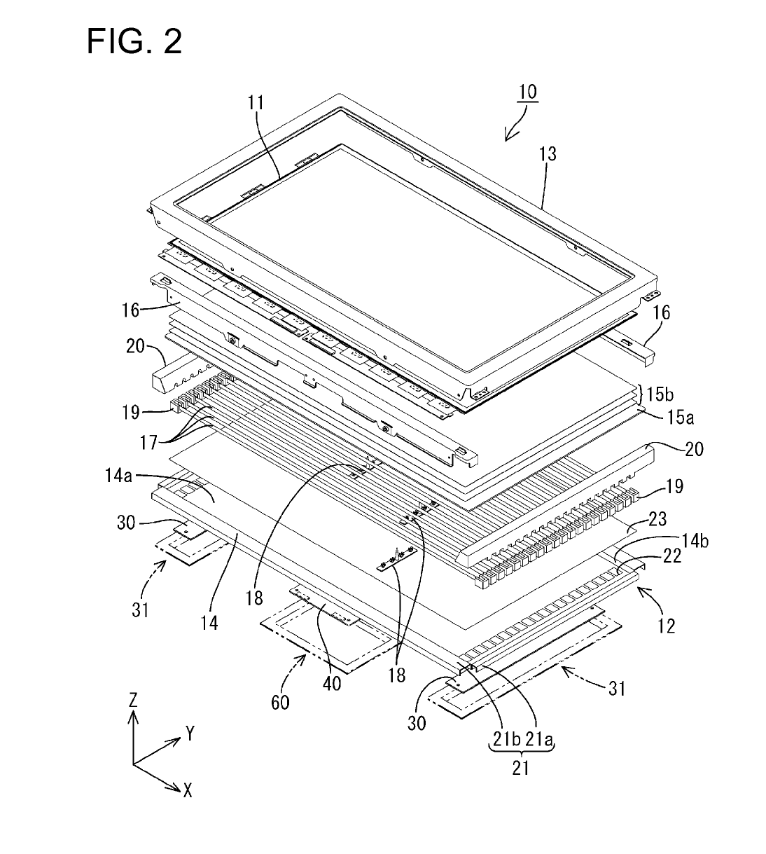

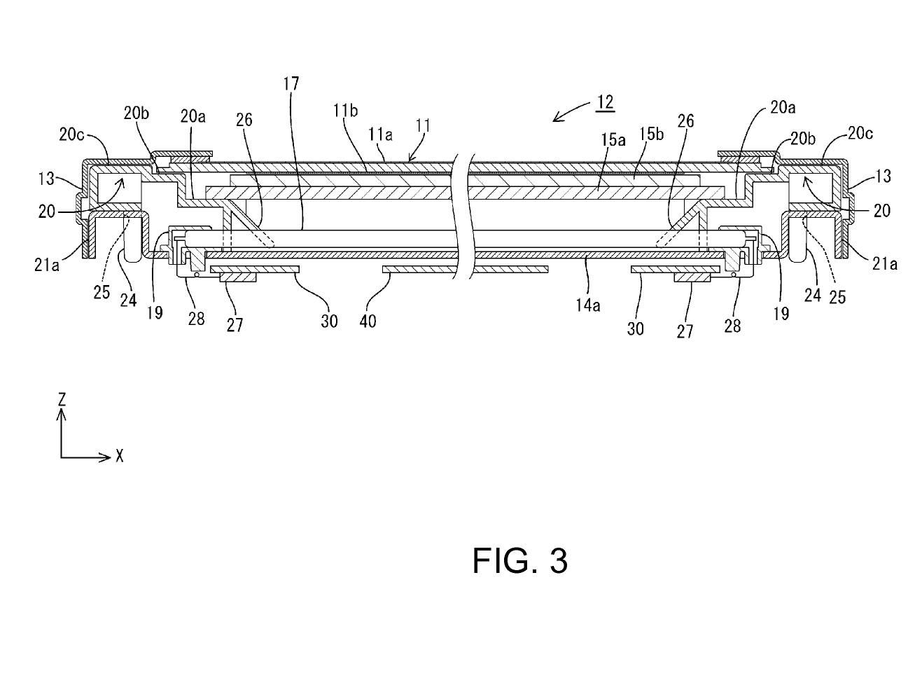

Embodiment 1 of the present invention will be described with reference to FIGS. 1 to 9. First, the configuration of a television receiver TV that includes a liquid crystal display device 10 will be described. FIG. 1 is an exploded perspective view of a schematic configuration of a television receiver of the present embodiment, FIG. 2 is an exploded perspective view of a schematic configuration of a liquid crystal display device included in the television receiver of FIG. 1, and FIG. 3 is a cross-sectional view of the liquid crystal display device of FIG. 2 along the longer side direction. The longer side direction of the liquid crystal display device 10 (and a chassis 14) is the X axis direction, and the shorter side direction thereof is the Y axis direction. The up and down direction in FIG. 3 is the Z axis direction (front/rear direction), the upward direction in FIG. 3 is the front side, and the downward direction therein is the rear side.

As shown in FIG. 1, the television receiver TV of the present embodiment includes the liquid crystal display device 10, front and rear cabinets Ca and Cb that sandwich the liquid crystal display device 10, a power source substrate P, a tuner T, and a stand S. The liquid crystal display device 10 (display device) as a whole has a horizontally long rectangular shape, and is stored in a vertical orientation (in which the shorter side direction corresponds to the vertical direction). As shown in FIG. 2, the liquid crystal display device 10 includes a liquid crystal panel 11 (display panel), and a backlight device 12 (illumination device) that is an external light source, and these are held together integrally using a frame shaped bezel 13 or the like.

Next, the liquid crystal panel 11 and the backlight device 12, which constitute the liquid crystal display device 10, will be described. The liquid crystal panel 11 conducts display using light from the backlight device 12, and has a pair of glass substrates bonded together with a prescribed gap therebetween, and liquid crystal is sealed between the glass substrates. One of the glass substrates is provided with switching elements (TFTs, for example) connected to source wiring lines and gate wiring lines that intersect each other perpendicularly, pixel electrodes connected to the switching elements, an alignment film, and the like, and the other glass substrate is provided with color filters made of colored parts of R (red), G (green), B (blue), and the like disposed in a prescribed arrangement, an opposite electrode, an alignment film, and the like. Polarizing plates 11a and 11b are attached to the outer sides of the respective substrates (refer to FIG. 3).

As shown in FIG. 2, the backlight device 12 includes a substantially box-shaped chassis 14 having an opening 14b on the side towards which light is emitted (liquid crystal panel 11 side), a diffusion plate 15a attached covering the opening 14b of the chassis 14, a plurality of optical sheets 15b disposed between the diffusion plate 15a and the liquid crystal panel 11, and frames 16 that are disposed along the longer sides of the chassis 14 and that hold in place the longer side edges of the diffusion plate 15a between the chassis 14 and the frames 16.

In addition, the following are stored in the chassis 14: cold cathode tubes 17 (light sources); lamp clips 18 for attaching the cold cathode tubes 17 to the chassis 14; relay connectors 19 that act as a relay for the electrical connection at the respective ends of the cold cathode tubes 17; and holders 20 that cover all of the ends of the group of the cold cathode tubes 17 and the group of relay connectors 19. In the backlight device 12, the side closer to the diffusion plate 15a than the cold cathode tubes 17 is the side towards which light is emitted.

The chassis 14 is formed in a substantially box shape of a plate-shape conductive material (a metal, for example) by sheet metal-forming. Specifically, the chassis 14 has a substantially box shape including the bottom plate 14a that is a flat rectangular plate, and outer edges 21 that are folded up from the respective sides of the bottom plate 14a, forming a substantially U shape (shorter side outer edges 21a in the shorter side direction and the longer side outer edges 21b in the longer side direction).

In the bottom plate 14a of the chassis 14, a plurality of attaching holes 22 for attaching the relay connectors 19 are formed through both edges aligned in the longer side direction. In addition, fixing holes (not shown in drawings) are formed through the upper surface of the longer side outer edges 21b of the chassis 14, and it is thus possible to assemble together the bezel 13, the frames 16, the chassis 14, and the like using screws or the like, for example.

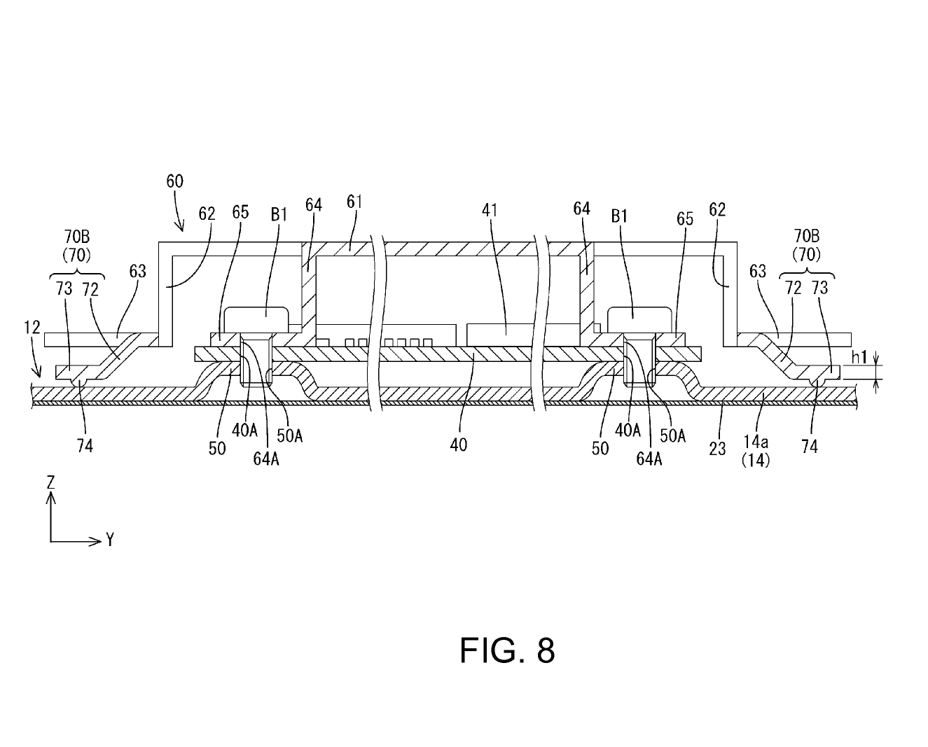

As shown in FIGS. 2 and 8, a light reflective sheet 23 is disposed on the inner surface side of the bottom plate 14a of the chassis 14 (on the surface side facing the cold cathode tubes 17). The light reflective sheet 23 is made of a synthetic resin and has a surface that is a highly reflective white, and is laid covering almost the entire bottom plate 14a of the chassis 14 along the inner surface thereof (FIG. 3 does not show the light reflective sheet). With the light reflective sheet 23, it is possible to reflect light emitted from the cold cathode tubes 17 towards the diffusion plate 15a.

On the other hand, the diffusion plate 15a and the optical sheets 15b are disposed at the opening 14b of the chassis 14. The diffusion plate 15a is made by dispersing light diffusing particles in the synthetic resin plate-shaped member, and has the function of diffusing linear light emitted from the cold cathode tubes 17, which are line-shaped light sources. The shorter side edges of the diffusion plate 15a are disposed on the first surfaces 20a of the holders 20 as described above, and are not restrained in the up and down direction. On the other hand, the longer side edges of the diffusion plate 15a are fixed in place by being sandwiched between the chassis 14 and the frames 16.

The optical sheets 15b disposed on the diffusion plate 15a include a diffusion sheet, a lens sheet, and a reflective polarizing plate layered in that order from the diffusion plate 15a, and have the function of converting light emitted from the cold cathode tubes 17 and passing through the diffusion plate 15a into planar light. The liquid crystal panel 11 is disposed over the optical sheets 15b, and the optical sheets 15b are sandwiched between the diffusion plate 15a and the liquid crystal panel 11.

The cold cathode tubes 17 are narrow tubes disposed such that the longer side direction (axis direction) thereof matches the longer side direction of the chassis 14, with the plurality of cold cathode tubes 17 (20 in the present embodiment) being stored in the chassis 14 parallel to each other (refer to FIG. 2). Terminals (not shown in drawings) that receive drive power are provided on the respective ends of the cold cathode tubes 17, the terminals are inserted inside the relay connectors 19, and the holders 20 are attached covering the relay connectors 19.

The holders 20 that cover the ends of the cold cathode tubes 17 are made of a white synthetic resin, and have a narrow substantially box shape that extends along the shorter side direction of the chassis 14. The holders 20 are disposed partially overlapping the shorter side outer edges 21a of the chassis 14, and constitute the side walls of the backlight device 12 along with the shorter side outer edges 21a. As shown in FIG. 3, insertion pins 24 protrude from a surface of the holders 20 facing the folded over outer edges 21a of the chassis 14, and as a result of the insertion pins 24 being inserted into insertion holes 25 formed in the upper surface of the shorter side outer edges 21a of the chassis 14, the holders 20 are attached to the chassis 14.

As shown in FIG. 3, the step-shaped surfaces of the holders 20 include three surfaces parallel to the bottom plate 14a of the chassis 14, and the shorter side edges of the diffusion plate 15a are placed on the first surfaces 20a, which are at the lowest position. In addition, inclined covers 26 that are inclined towards the bottom plate 14a of the chassis 14 extend from the first surfaces 20a. On the second surfaces 20b of the step-shaped surfaces of the holders 20, the shorter side edges of the liquid crystal panel 11 are placed. The third surfaces 20c of the step-shaped surfaces of the holder 20 are at the highest position, are disposed in positions overlapping the shorter side outer edges 21a of the chassis 14, and are in contact with the bezel 13.

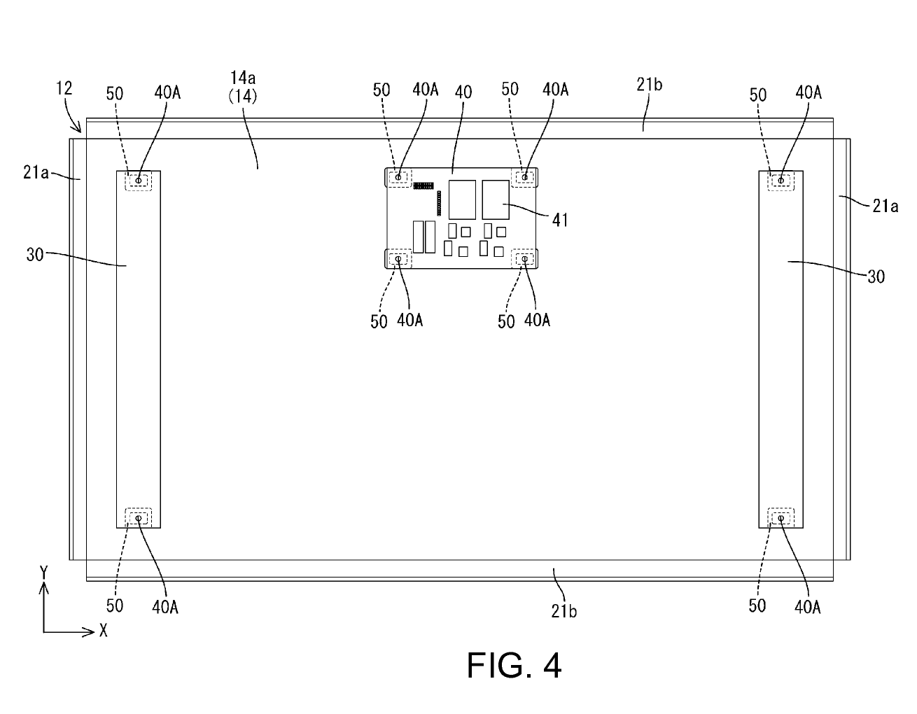

As shown in FIGS. 2 and 4, inverter substrates 30 and a control substrate 40 are attached to the outer side (side opposite to the cold cathode tubes 17; rear side) of the bottom plate 14a of the chassis 14. The above-mentioned power source substrate P (refer to FIG. 1; not shown in FIG. 4) is electrically connected to the inverter substrates 30, the control substrate 40, and the like, and is an electrical power source that supplies electrical power thereto.

As shown in FIG. 4, the inverter substrates 30 are respectively provided on both edges of the chassis 14, aligned in the longer side direction thereof, and have rectangular shapes that extend along the shorter side direction of the chassis 14. Each inverter substrate 30 is electrically connected to the cold cathode tubes 17 through connectors 27 and harnesses 28. The inverter substrates 30 have the function of switching the cold cathode tubes 17 on (or off) by increasing the voltage inputted from the power source substrate P using inverter circuits constituted of transformers and the like, outputting the voltage, which is higher than the voltage inputted from the power source substrate P, to the cold cathode tubes 17, and the like.

As shown in FIG. 4, the control substrate 40 (circuit board) has a rectangular shape that is long in the longer side direction (X axis direction) of the chassis 14 in a plan view. The control substrate 40 is disposed in the center of the longer side direction of the chassis 14 and towards one side of the shorter side direction (upper side of FIG. 4) of the chassis 14.

In the control substrate 40, circuit parts 41 are installed on a substrate made of a synthetic resin (such as phenolic paper or a glass epoxy resin, for example), and the control substrate 40 has a function and the like of converting various input signals such as television signals from the tuner T to signals to drive the liquid crystal, and supplying these converted signals for driving the liquid crystal to the liquid crystal panel 11.

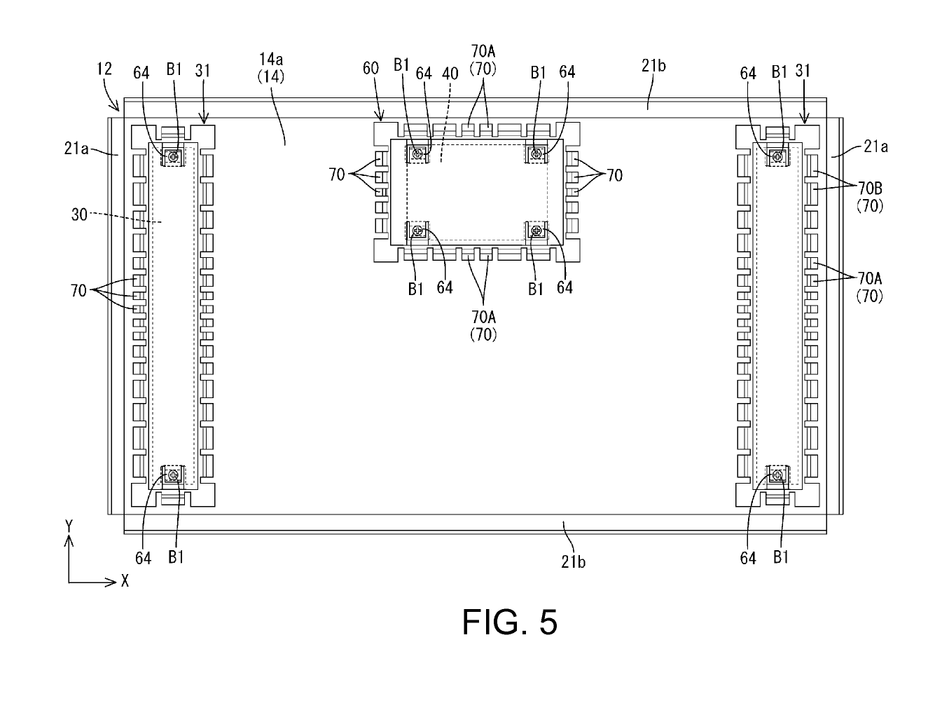

As shown in FIGS. 2 and 5, a substrate cover 60 is attached to the bottom plate 14a of the chassis 14 so as to cover the control substrate 40. Also, substrate covers 31 covering the respective inverter substrates 30 are attached to the bottom plate 14a of the chassis 14. FIGS. 3 and 4 show a state in which the substrate covers 60 and 31 are removed. Such substrate covers 60 and 31 are designed to protect the substrates 40 and 30, and also have a function of preventing a hand or the like from coming into contact with the substrates when the substrates become hot during substrate driving, for example.

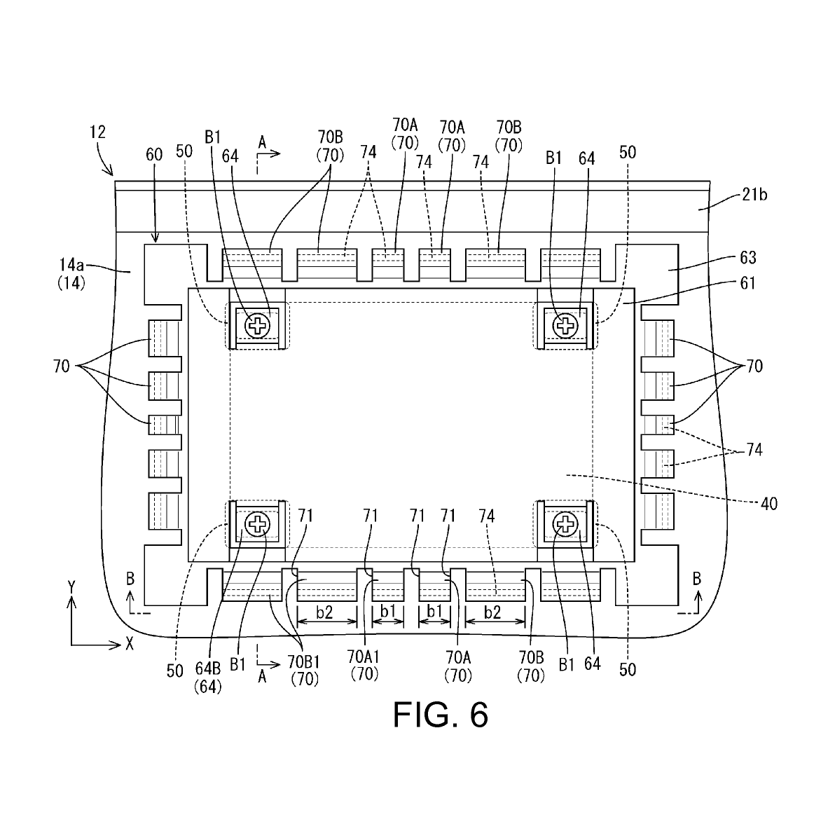

Next, the configuration of the substrate cover 60 will be described with reference to FIGS. 5 to 9. As shown in FIGS. 5 and 6, the substrate cover 60 has a rectangular shape in a plan view, and is constituted of a plate-shaped conductive material (a metal material, for example) that is formed by sheet metal-forming.

The substrate cover 60 has a substantially box shape that is open on the side facing the chassis 14, and as shown in FIG. 8, has a main wall 61 disposed such that the control substrate 40 is sandwiched between the chassis 14 and the main wall 61, four side walls 62 that respectively rise from the four peripheral edges of the main wall 61 towards the chassis 14, and a peripheral section 63 that extends from the tips of the respective side walls 62.

As shown in FIG. 6, the main wall 61 of the substrate 60 is a rectangle slightly larger than the control substrate 40, and covers the control substrate 40 in a plan view. As shown in FIG. 8, in the substrate cover 60, the main wall 61 and the peripheral section 63 extend along the extension direction of the control substrate 40 and the bottom plate 14a of the chassis 14. In other words, the main wall 61 and the peripheral section 63 are disposed opposite to the bottom plate 14a of the chassis 14, and parallel thereto.

The control substrate 40 and the substrate cover 60 are attached to attaching platforms 50 formed on the bottom plate 14a of the chassis 14 with screws B1. The attaching platforms 50 are respectively formed in positions corresponding to the four corners of the substrate cover 60 (and the control substrate 40) on an outer side chassis surface at the bottom plate 14a of the chassis 14.

As shown in FIGS. 6 and 8, the attaching platforms 50 have a rectangular shape in a plan view, and are formed by having a portion of the bottom plate 14a protrude toward the outer surface side of the chassis (rear side; upper side of FIG. 8). The substrate cover 60 (and the control substrate 40) is disposed covering the plurality of attaching platforms 50.

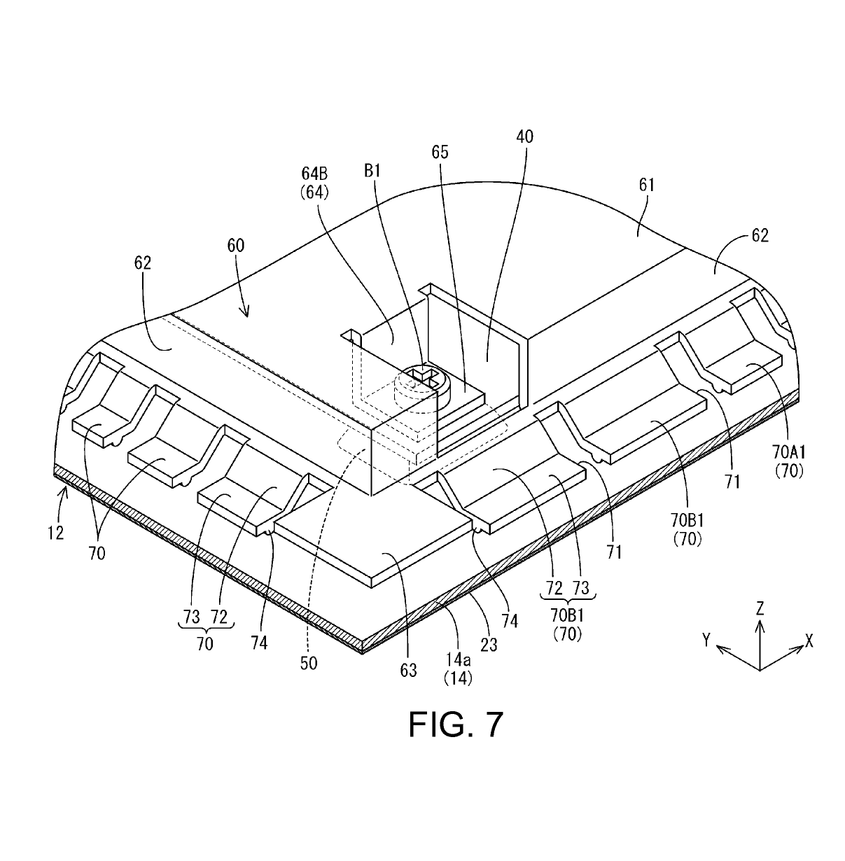

As shown in FIG. 7, portions of the main wall 61 of the substrate cover 60 corresponding in position to the respective attaching platforms 50 are punched through and bent towards the attaching platforms 50, thus forming attaching parts 64. The attaching parts 64 are bent in a substantially L shape, and the tips 65 thereof extend along the extension direction of the control substrate 40.

As shown in FIG. 8, the tips 65 of the attaching parts 64 are respectively penetrated by insertion holes 64A through which screws B1 can be respectively inserted. Insertion holes 40A through which the screws B1 can be inserted are formed through the control substrate 40 so as to match in position with the insertion holes 64A. The attaching platforms 50 of the chassis 14 have attaching holes 50A, the inner surfaces thereof having threading for screws. The screws B1 are inserted into both the insertion holes 64A of the substrate cover 60 and the insertion holes 40A of the control substrate 40, and then the tips of the screws B1 are screwed into the attaching holes 50A, thereby attaching the control substrate 40 and the substrate cover 60 to the chassis 14.

The peripheral section 63 of the substrate cover 60 is provided with a plurality of contact pieces 70 in contact with the chassis 14. More specifically, as shown in FIG. 7, in order to form each contact piece 70, a plurality of cut out portions 71 are formed in the peripheral section 63, which has a substantially rectangular frame shape in a plan view, and then, portions of the peripheral section 63 are bent towards the chassis 14. In other words, the contact pieces 70 are formed extending towards the chassis 14 from the side walls 62. As shown in FIG. 6, the plurality of contact pieces 70 are disposed in a row along the entire peripheral section 63 (four peripheral sides) of the substrate cover 60.

As shown in FIG. 8, the contact pieces 70 have plate shapes, and each has a base 72 extending from a side wall 62, and a tip 73 extending from the base 72 so as to be substantially parallel to the bottom plate 14a of the chassis 14. The surface of the tip 73 facing the bottom plate 14a has a protrusion 74 formed protruding towards the bottom plate 14a. The protrusion 74 is formed extending along the plate width direction of the contact piece 70. The substrate cover 60 is electrically connected to the chassis 14 by having the protrusions 74 in contact with the bottom plate 14a of the chassis 14.

The contact pieces 70 are in contact with the bottom plate 14a while warping in the plate thickness direction. “In contact while warping” refers to the fact that the contact pieces 70 are in contact with the bottom plate 14a while being elastically deformed towards a side opposite to the chassis 14 in the plate thickness direction. With this configuration, the protrusions 74 of the contact pieces 70 are in contact with the bottom plate 14a of the chassis 14 with a certain amount of contact pressure, which allows more reliable contact between the protrusions 74 and the bottom plate 14a.

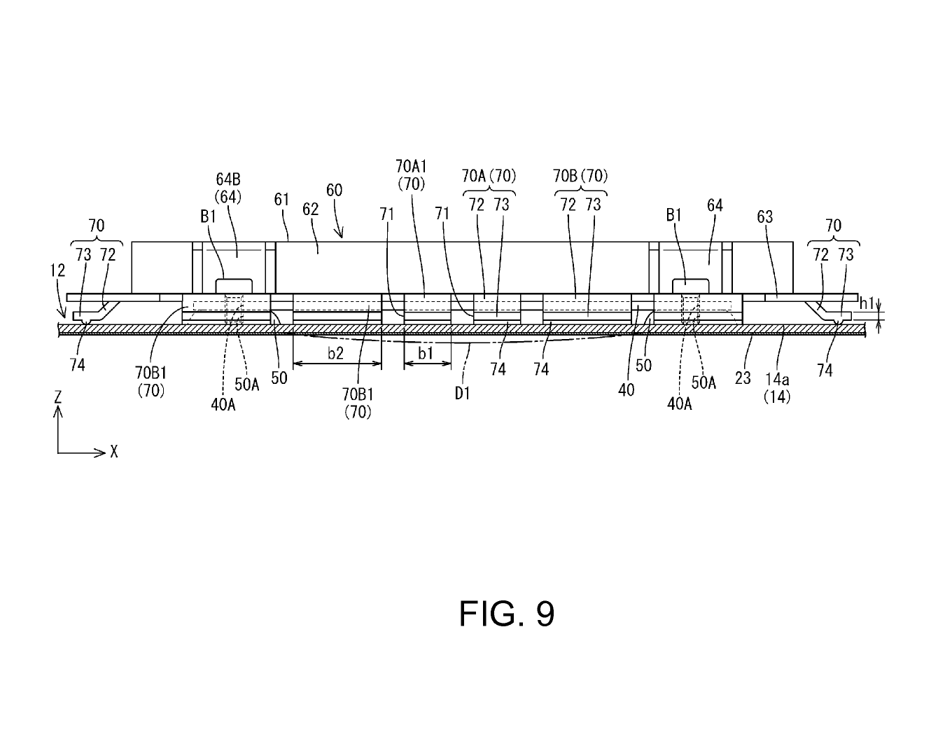

Of the peripheral section of the substrate cover 60, both edges aligned in the shorter side direction (Y axis direction) have a plurality (six in the present embodiment) of contact pieces 70 disposed along the longer side direction (X axis direction). As shown in FIGS. 6 and 9, of the plurality of contact pieces 70 disposed along the X axis direction, a plate width b1 of each of the two contact pieces 70 disposed towards the center (hereinafter referred to as first contact pieces 70A) is less than a plate width b2 of contact pieces 70 disposed towards the edges (hereinafter referred to as second contact pieces 70B). The plate width of each of the contact pieces 70 refers to the length thereof in the longer side direction in a cross-sectional view. A plate thickness hl (refer to FIG. 8) of each contact piece 70 is the same as the plate thickness of the substrate cover 60, for example, and is the same for all contact pieces 70.

In each contact piece 70, the cross-section thereof intersecting perpendicularly with the extension direction of the contact piece 70 is rectangular. The second moment of area “I” along the plate thickness direction of a rectangular cross-section is represented by the following Formula 1, where “h” is the plate thickness and “b” is the plate width.

<Formula 1>

I=(b*ĥ3)/12 (1)

According to Formula 1, the second moment of area of the contact piece 70 is proportional to the plate thickness and the plate width thereof. Thus, the second moment of area of the cross-section intersecting perpendicularly with the extension direction of the first contact piece 70A is smaller than the second moment of area of the cross-section intersecting with the extension direction of the second contact piece 70B. In other words, the first contact piece 70A has a configuration with a greater susceptibility to warping in the plate thickness direction (shape with a susceptibility to warping) than the second contact piece 70B.

Next, the plan view positional relation between the first contact pieces 70A and the second contact pieces 70B disposed along the longer side direction of the substrate cover 60 and the attaching parts 64 adjacent thereto will be described. The first contact pieces 70A are disposed in positions relatively far from the attaching parts 64 of the substrate cover 60 adjacent thereto, and the second contact pieces 70B are disposed relatively close to the attaching parts 64 of the substrate cover 60. Of the four attaching parts 64, for example, an attaching part 64B on the lower left of FIG. 6, and the first contact piece 70A (first contact piece 70A1 in FIGS. 6 and 9) and the second contact pieces 70B (second contact pieces 70B1 in FIGS. 6 and 9) adjacent to the attaching part 64B will be described as examples. The first contact piece 70A1 is disposed relatively far from the attaching part 64B of the substrate cover 60 adjacent thereto, and the second contact pieces 70B 1 are disposed relatively close to the attaching part 64B of the substrate cover 60. In other words, the second contact pieces 70B 1 are closer to the attaching part 64B than the first contact piece 70A.

The contact pieces 70 disposed along the shorter side direction (Y axis direction) of the substrate cover 60 have a similar configuration to the contact pieces 70 disposed along the longer side direction (X axis direction). In other words, the contact pieces 70 that are relatively far from the adjacent attaching parts 64 have a smaller plate width than the contact pieces 70 that are relatively close to the attaching parts 64. Specifically, the contact pieces 70 disposed along the Y axis direction have a smaller plate width, the closer they are to the center.

In the present embodiment, as shown in FIG. 5, the attaching platforms 50 are respectively provided in positions on the bottom plate 14a of the chassis 14 corresponding to the respective ends in the longer side direction of the inverter substrates 30, and the inverter substrates 30 and the substrate covers 31 are attached by screws B1. As in the substrate cover 60, the substrate covers 31 also have contact pieces 70 that have a narrower plate width the further from the attaching parts 64 they are.

As described above, the backlight device 12 of the present embodiment includes: a cold cathode tube 17; a chassis 14 that stores the cold cathode tube 17; a control substrate 40 attached to the chassis 14; and a substrate cover 60 attached to the chassis 14 and disposed so as to cover the control substrate 40, the substrate cover 60 and the chassis 14 being made of a conductive material, the substrate cover 60 having an attaching part 64 attached to the chassis 14, and a plurality of contact pieces 70 extending towards the chassis 14 and in contact therewith, the plurality of contact pieces 70 having a plate shape and being in contact with the chassis 14 while warping in a plate thickness direction, the first contact piece 70A1 being more susceptible to warping in the plate thickness direction thereof than the second contact piece 70B 1 where, of the plurality of contact pieces 70, contact pieces 70 disposed in a position relatively far from the attaching part 64 (attaching part 64B, for example) of the substrate cover 60 are first contact pieces 70A (the first contact piece 70A1, for example), and contact pieces 70 disposed relatively close to the attaching part 64B of the substrate cover 60 are second contact pieces 70B (the first contact piece 70B1, for example).

In the present embodiment, the substrate cover 60 and the chassis 14 are made of a conductive material, and the substrate cover 60 is electrically connected to the chassis 14 through the contact pieces 70 extending from the substrate cover 60 and in contact with the chassis 14. With this configuration, when driving the control substrate 40, even if electromagnetic waves are emitted from the control substrate 40, the substrate cover 60 and the chassis 14 effectively shield the control substrate 40 so as to prevent electromagnetic waves from leaking out, and thus, it is possible to mitigate the emission of electromagnetic waves to the outside. It is possible to electrically connect the substrate cover 60 to the chassis 14 by using a simple configuration in which the contact pieces 70 extend from the substrate cover 60, and thus, it is possible to improve productivity compared to a case in which a conductive member such as a gasket is used.

If the contact pieces 70 are in contact (elastically) with the chassis 14 while being warped, the chassis 14 receives pressure from the contact pieces 70, which results in cases in which the chassis 14 is pushed away from the substrate cover 60. FIG. 9 schematically shows, through the two-dot chain line D1, the bottom plate 14a of the chassis 14 in a state in which the bottom plate 14a is warped away from the substrate cover 60. The warping of the chassis 14 shown with the two-dot chain line D1 is schematic, and thus, the warping state (amount of warping) and the like are not limited to that shown with the two-dot chain line D1 in FIG. 9.

If the chassis 14 warps in this manner, the contact pressure between the contact pieces 70 and the chassis 14 becomes smaller, which can result in insufficient contact between the contact pieces 70 and the chassis 14, which is undesirable. In the configuration of the present embodiment, the attaching parts 64 of the substrate cover 60 are attached to the chassis 14. Thus, if the chassis 14 receives pressure from the contact pieces 70 (substrate cover side), portions of the chassis 14 further from the attaching parts 64 (where the chassis 14 and the substrate cover 60 are attached) of the substrate cover 60 are more susceptible to warping.

In the present embodiment, of the plurality of contact pieces 70, the first contact pieces 70A, which are relatively far from the attaching parts 64 (attaching locations), are more susceptible to warping than the second contact pieces 70B, which are relatively close to the attaching parts 64. As a result, when comparing the pressure on the chassis 14 from the first contact pieces 70A to that from the second contact pieces 70B, the pressure from the first contact pieces 70A, which are relatively far from the attaching parts 64, is smaller than the pressure from the second contact pieces 70B, which are relatively close to the attaching parts 64. As a result, it is possible to effectively mitigate warping in the chassis 14 in positions pressed by the first contact pieces 70A (positions that are more susceptible to warping than positions pressed by the second contact pieces 70B), which allows the contact pieces 70 to be more reliably in contact with the chassis 14. Thus, the substrate cover 60 can be more reliably connected electrically to the chassis 14, which allows the electromagnetic shielding effect of the substrate cover 60 and the chassis 14 to be greater.

The plurality of contact pieces 70 are disposed along the entire peripheral section 63 of the substrate cover 60. As a result of the plurality of contact pieces 70 being disposed along the entire periphery of the substrate cover 60, when each contact piece 70 is in contact with the chassis 14 while being warped, the counterforce from each of the contact pieces 70 can be balanced throughout the entire periphery of the substrate cover 60. As a result, it is possible to mitigate a situation in which the substrate cover 60 is tilted to one side with respect to the chassis 14, and the contact pressure from the respective contact pieces 70 on the chassis 14 can be made more even. As a result, the contact pieces 70 can be more reliably in contact with the chassis 14.

The substrate cover 60 has the main wall 61 disposed such that the control substrate 40 is sandwiched between the chassis 14 and the main wall 61, and the side walls 62 that rise towards the chassis 14 from the periphery of the main wall 61, and of the plurality of contact pieces 70, at least one of the contact pieces 70 extends from a side wall 62.

If the contact pieces 70 are configured so as to extend from the side walls 62, compared to a case in which the contact pieces 70 extend from the main wall 61, for example, the extension length of the contact pieces 70 can be made shorter. As a result, it is possible to reduce the cost of forming the contact pieces 70.

Of the plurality of contact pieces 70, a protrusion 74 protruding towards the chassis 14 is formed on the tip 73 of at least one contact piece 70, and the protrusion 74 is in contact with the chassis 14.

In the present embodiment, the protrusions 74 of the contact pieces 70 are in contact with the chassis 14. With this configuration, it is possible to adjust the contact pressure on the chassis 14 with ease by adjusting the height of the protrusions 74 when forming the protrusions 74.

### Embodiment 2

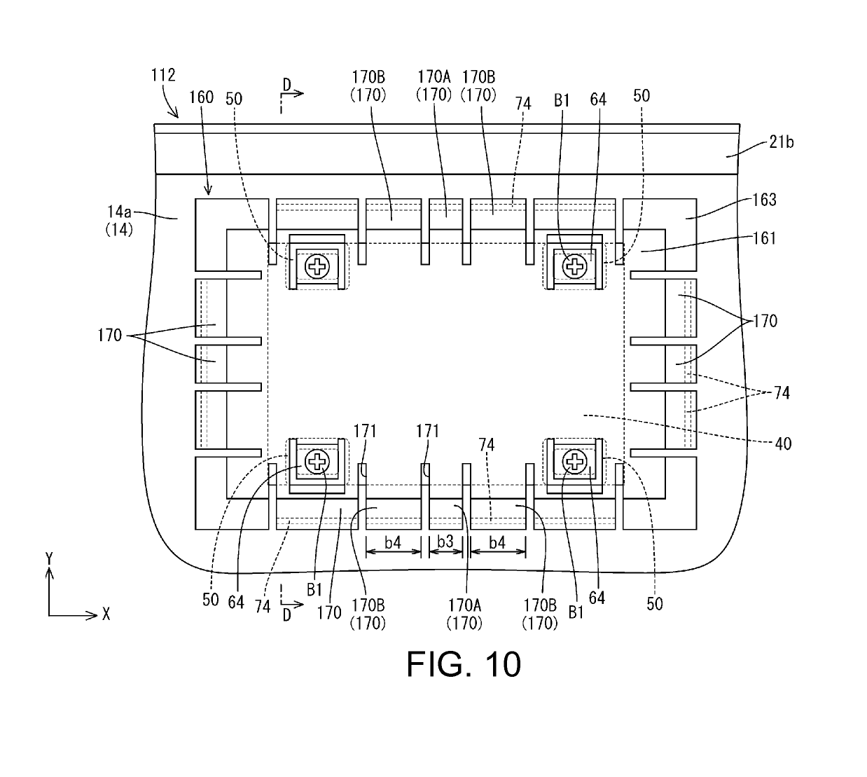

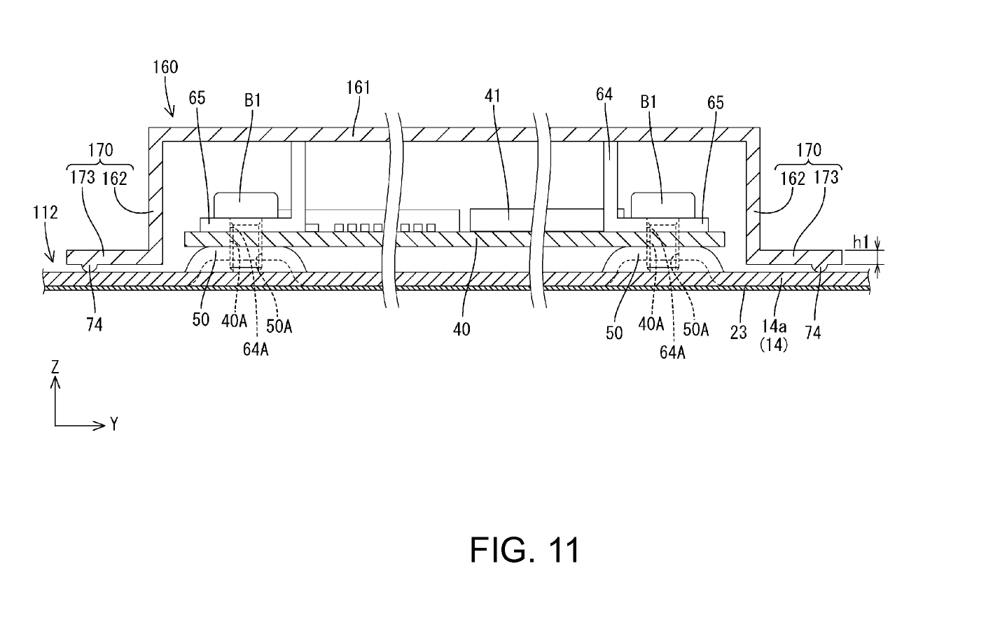

Next, Embodiment 2 of the present invention will be described with reference to FIGS. 10 and 11. Parts that are the same as those in the embodiment above are assigned the same reference characters, and redundant descriptions thereof will be omitted. As shown in FIGS. 10 and 11, in a backlight device 112 of the present embodiment, the configuration of contact pieces on a substrate cover is different from that of the embodiment above.

Contact pieces 170 of the present embodiment extend from a main wall 161 of a substrate cover 160. More specifically, the respective contact pieces 170 are portions of the substrate cover 160 made elastically deformable by forming a plurality of cut out portions 171 across a peripheral portion 163 from the main wall 161. In other words, the contact pieces 170 each constitute a portion of a side wall 162 and a portion of the peripheral section 163 (reference character 173 in FIG. 11) of the substrate cover 160. As in the previous embodiment, in the present embodiment, a plate width b3 of first contact pieces 170A disposed relatively far from attaching parts 64 is smaller than a plate width b4 of second contact pieces 170B.

Because the contact pieces 170 of the present embodiment are in contact with the chassis 14 while being warped in the plate thickness direction, it is preferable that the contact pieces 170 be susceptible to warping to a certain degree. If the contact pieces 170 extend from the main wall 161 as in the present embodiment, it is possible to make the extension length of the contact pieces 170 longer than in a configuration in which the contact pieces 170 extend from the side walls 162, for example. Thus, the contact pieces 170 can be made more susceptible to warping in the plate thickness direction, and can be formed with greater ease. As a result, it is possible to reduce the cost of forming the contact pieces 170.

If the contact pieces 170 are formed by cutting out portions of the substrate cover 160 as in the present embodiment, it is preferable that the number of cut out portions 171 (and by extension, the total area of the cut out portions 171) be as small as possible in order to increase the electromagnetic shielding effect of the substrate cover 160. However, if the number of cut out portions 171 is reduced (or in other words, the number of contact pieces 170 is reduced), the plate width of the contact pieces 170 is increased. As a result, the contact pieces 170 become less susceptible to warping, thus making it difficult to have the contact pieces 170 be elastically in contact (while warping) with the chassis 14.

In the present embodiment, the contact pieces 170 extend from the main wall 161, thus increasing the extension length of the contact pieces 170, and increasing the susceptibility of the contact pieces 170 to warping. As a result, even if the plate width of the contact pieces 170 becomes large as a result of decreasing the number of cut out portions 171, it is possible to have contact pieces 170 be susceptible to warping.

### Embodiment 3

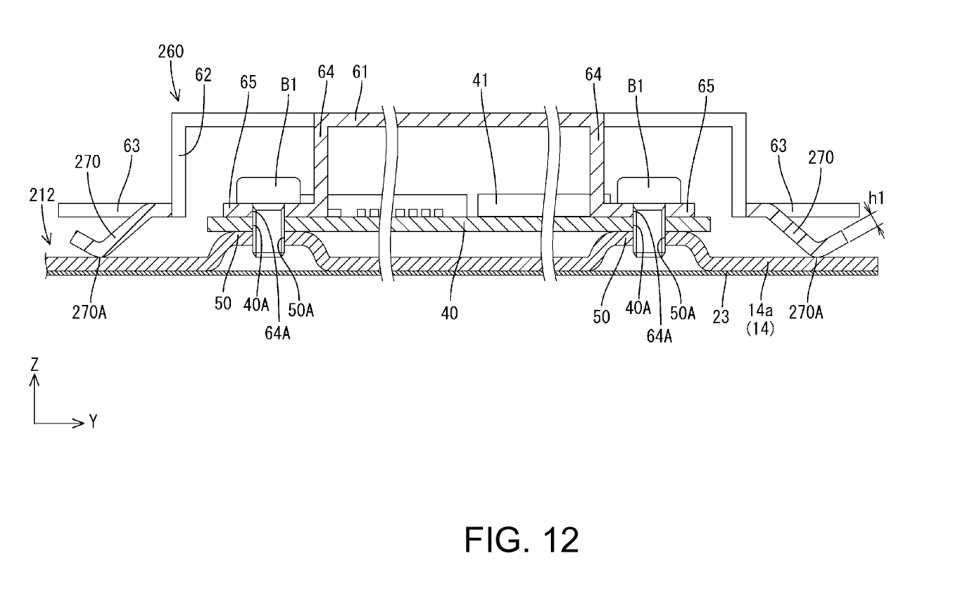

Next, Embodiment 3 of the present invention will be described with reference to FIG. 12. Parts that are the same as those in the embodiments above are assigned the same reference characters, and redundant descriptions thereof will be omitted. As shown in FIG. 12, in a backlight device 212 of the present embodiment, the configuration of contact pieces on a substrate cover is different from those of the embodiments above.

Contact pieces 270 of the present embodiment extend towards a bottom plate 14a at an incline with respect to a peripheral section 63. The contact pieces 270 do not have protrusions 74 similar to those of the embodiments above, and the tips of the contact pieces 270 have a bend protruding towards the chassis 14. As a result, contact surfaces 270A of the contact pieces 270 in contact with the bottom plate 14a of the chassis 14 have a bent surface with the bend protruding towards the chassis 14.

If the contact surface 270A in contact with the chassis 14 has a bend protruding towards the chassis 14, then when the contact surface 270A is in contact with the chassis 14, the contact piece 270 becomes susceptible to deforming due to being pressed against the bottom plate 14a of the chassis 14. As a result, the contact surface 270A is more easily put in contact with the bottom surface 14a of the chassis 14, which allows the chassis 14 and the contact surface 270A to be more reliably in contact with each other. As a result, it is possible to mitigate vibration in the contact pieces 270 when the backlight device 212 is being driven, which allows unwanted noises to be mitigated.

The following configurations can also be used for Embodiments 1 to 3.

(1) In the above embodiments, the first contact pieces 70A are made more susceptible to warping than the second contact pieces 70B by making the plate width b1 of the first contact pieces 70A smaller than the plate width b2 of the second contact pieces 70B, but the configuration is not limited thereto. A configuration may be used in which the plate width of the first contact pieces 70A and the second contact pieces 70B is the same with the plate thickness of the first contact pieces 70A being less than that of the second contact pieces 70B, for example. In other words, any configuration may be used as long as the first contact pieces 70A are more susceptible to warping than the second contact pieces 70B. As for the cross-sectional shape of the contact pieces 70, as long as the second moment of area in the plate thickness direction of the first contact piece 70A is less than the second moment of area in the plate thickness direction of the second contact piece 70B, any shape may be used.

(2) The number and position of contact pieces 70, 170, and 270 are not limited to the examples of the embodiments above, and may be appropriately modified.

(3) The material of the chassis 14 and the substrate cover 60 is not limited to a metal. The material for the chassis 14 and the substrate cover 60 can be appropriately modified as long as the material is conductive.

(4) The method of attaching the control substrate 40 and the substrate cover 60 to the chassis 14 is not limited to using the screws B1, and the method can be appropriately modified. For example, a configuration may be used in which the control substrate 40 and the substrate cover 60 are attached to the chassis 14 using nuts, bolts, and the like. Alternatively, a configuration may be used in which the control substrate 40 and the substrate cover 60 are each attached separately to the chassis 14 by different attaching methods.

(5) The configuration of the attaching parts 64 of the substrate cover 60 is not limited to the examples of the embodiments above. The “attaching part” of the present invention refers to the portion of the substrate cover 60 attached to the chassis 14 (attaching position), and can be appropriately modified based on the attaching method of the substrate cover 60 to the chassis 14.

(6) The shape of the contact pieces 70 can be appropriately modified without being limited to the embodiments above. For example, a configuration may be used in which the cross-sectional shape of the second contact pieces 70B is a V shape so as to be less susceptible to warping than the first contact pieces 70A (in other words, a configuration in which the first contact pieces 70A are more susceptible to warping than the second contact pieces 70B).

(7) In the embodiments above, the control substrate 40 was given as an example of a circuit board, but the circuit board is not limited thereto. As long as the circuit board and the substrate cover can be attached to the chassis 14, the configuration of the present invention (a configuration in which the contact pieces are in contact with the chassis) can be applied.

(8) In the embodiments above, a case in which cold cathode tubes 17 are used as the light source was described, but the light source is not limited thereto. Hot cathode tubes, LEDs, or the like can also be used as the light source.

(9) In the embodiments above, the liquid crystal panel 11 and the chassis 14 are used in a vertical orientation such that the shorter side direction and the vertical direction match, but a case in which the liquid crystal panel 11 and the chassis 14 are used in a vertical orientation such that the longer side direction and the vertical direction match is also included in the present invention.

(10) In the embodiments above, TFTs are used as the switching elements in the liquid crystal display device 10, but the present invention can also be applied to a liquid crystal display device that uses switching elements other than TFTs (thin film diodes (TFD), for example), and, besides a color liquid crystal display device, the present invention can also be applied to a black and white liquid crystal display device.

(11) In the respective embodiments above, the liquid crystal display device 10 using the liquid crystal panel 11 as a display panel was described, but the present invention can also be applied to a display device that uses another type of display panel.

(12) In the respective embodiments above, the television receiver TV having a tuner T was described, but the present invention can also be applied to a display device that does not have a tuner.

### Embodiment 4

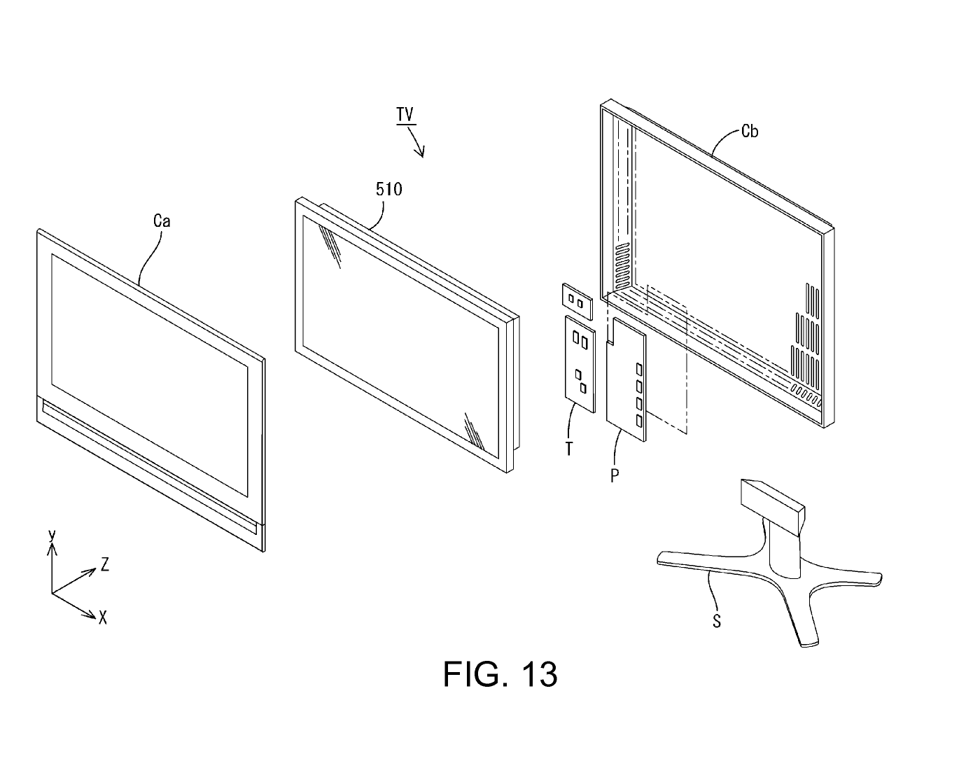

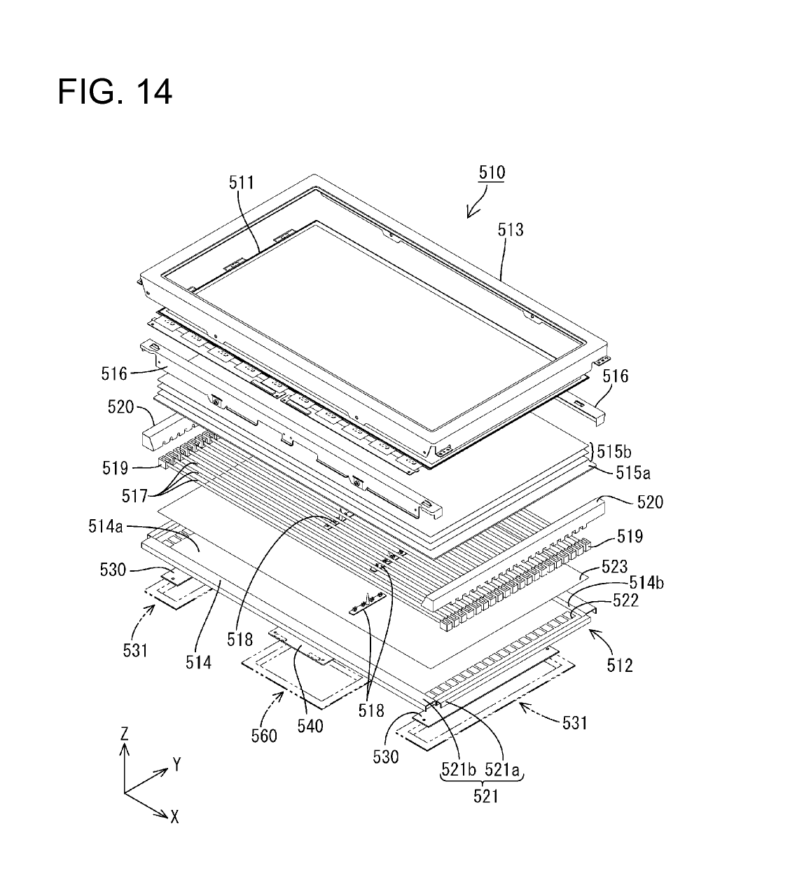

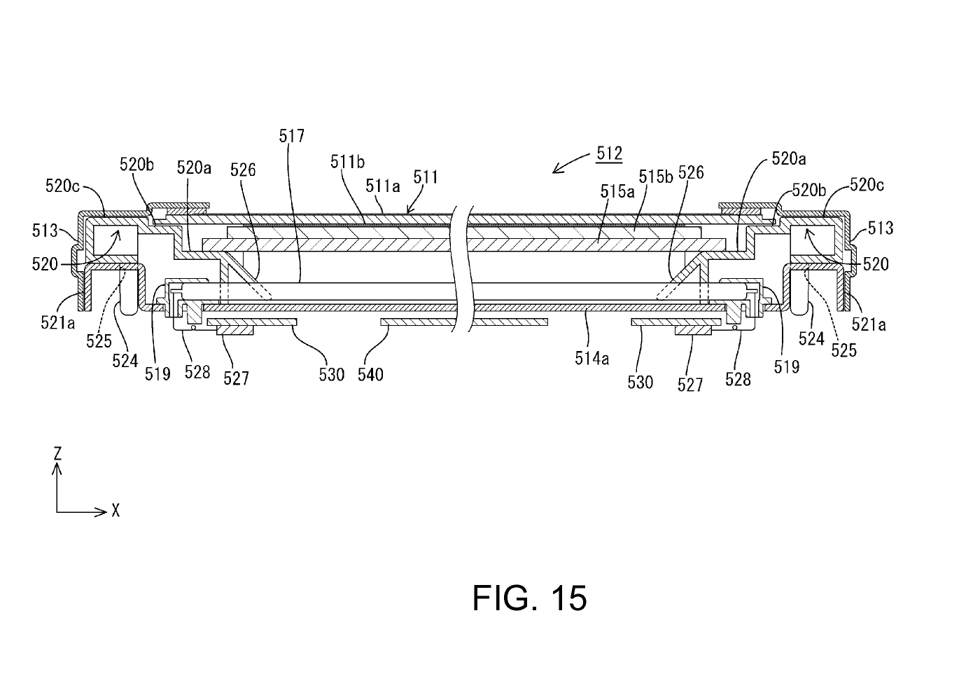

Next, Embodiment 4 of the present invention will be described with reference to FIGS. 13 to 25. First, the configuration of a television receiver TV that includes a liquid crystal display device 510 will be described. FIG. 13 is an exploded perspective view of a schematic configuration of a television receiver of the present embodiment, FIG. 14 is an exploded perspective view of a schematic configuration of a liquid crystal display device included in the television receiver of FIG. 13, and FIG. 15 is a cross-sectional view of a configuration of the liquid crystal display device of FIG. 14 along the longer side direction. The longer side direction of the liquid crystal display device 510 (and a chassis 514) is the X axis direction, and the shorter side direction is the Y axis direction. The up and down direction in FIG. 15 is the Z axis direction (front/rear direction), the upward direction in FIG. 12 is the front side, and the downward direction therein is the rear side.

As shown in FIG. 13, the television receiver TV of the present embodiment includes the liquid crystal display device 510, front and rear cabinets Ca and Cb that sandwich the liquid crystal display device 510, a power source substrate P, a tuner T, and a stand S. The liquid crystal display device 510 (display device) as a whole has a horizontally long rectangular shape, and is stored in a vertical orientation (in which the shorter side direction corresponds to the vertical direction). As shown in FIG. 14, the liquid crystal display device 510 includes a liquid crystal panel (display panel) 511, and a backlight device 512 (illumination device) that is an external light source, and these are held together integrally using a frame shaped bezel 513 or the like.

Next, the liquid crystal panel 511 and the backlight device 512, which constitute the liquid crystal display device 510, will be described. The liquid crystal panel 511 conducts display using light from the backlight device 512, and has a pair of glass substrates bonded together with a prescribed gap therebetween, and liquid crystal is sealed between the glass substrates. One of the glass substrates is provided with switching elements (TFTs, for example) connected to source wiring lines and gate wiring lines that intersect each other perpendicularly, pixel electrodes connected to the switching elements, an alignment film, and the like, and the other glass substrate is provided with color filters made of colored parts of R (red), G (green), B (blue), and the like disposed in a prescribed arrangement, an opposite electrode, an alignment film, and the like. Polarizing plates 511a and 511b are attached to the outer sides of the respective substrates (refer to FIG. 15).

As shown in FIG. 14, the backlight device 512 includes a substantially box-shaped chassis 514 having an opening 514b on the side towards which light is emitted (liquid crystal panel 511 side), a diffusion plate 515a attached covering the opening 514b of the chassis 514, a plurality of optical sheets 515b disposed between the diffusion plate 515a and the liquid crystal panel 511, and frames 516 that are disposed along the longer sides of the chassis 514 and that hold in place the longer side edges of the diffusion plate 515a between the chassis 514 and the frames 516.

In addition, the following are stored in the chassis 514: cold cathode tubes 517 (light sources); lamp clips 518 for attaching the cold cathode tubes 517 to the chassis 514; relay connectors 519 that act as a relay for the electrical connection at the respective ends of the cold cathode tubes 517; and holders 520 that cover all of the ends of the group of the cold cathode tubes 517 and the group of relay connectors 519. In the backlight device 512, the side closer to the diffusion plate 515a than the cold cathode tubes 517 is the light-emitting side.

The chassis 514 is formed in a substantially box shape of a plate-shape conductive material (a metal, for example) by sheet metal-forming. Specifically, the chassis 514 has a substantially box shape including a bottom plate 514a that is a flat rectangular plate, and outer edges 521 that are folded up from the respective sides of the bottom plate 514a, forming a substantially U shape (shorter side outer edges 521a in the shorter side direction and the longer side outer edges 521b in the longer side direction).

In the bottom plate 514a of the chassis 514, a plurality of attaching holes 522 for attaching the relay connectors 519 are formed through both edges in the longer side direction. In addition, fixing holes (not shown in drawings) are formed through the upper surface of the longer side outer edges 521b of the chassis 514, and it is thus possible to assemble together the bezel 513, the frames 516, the chassis 514, and the like using screws or the like, for example.

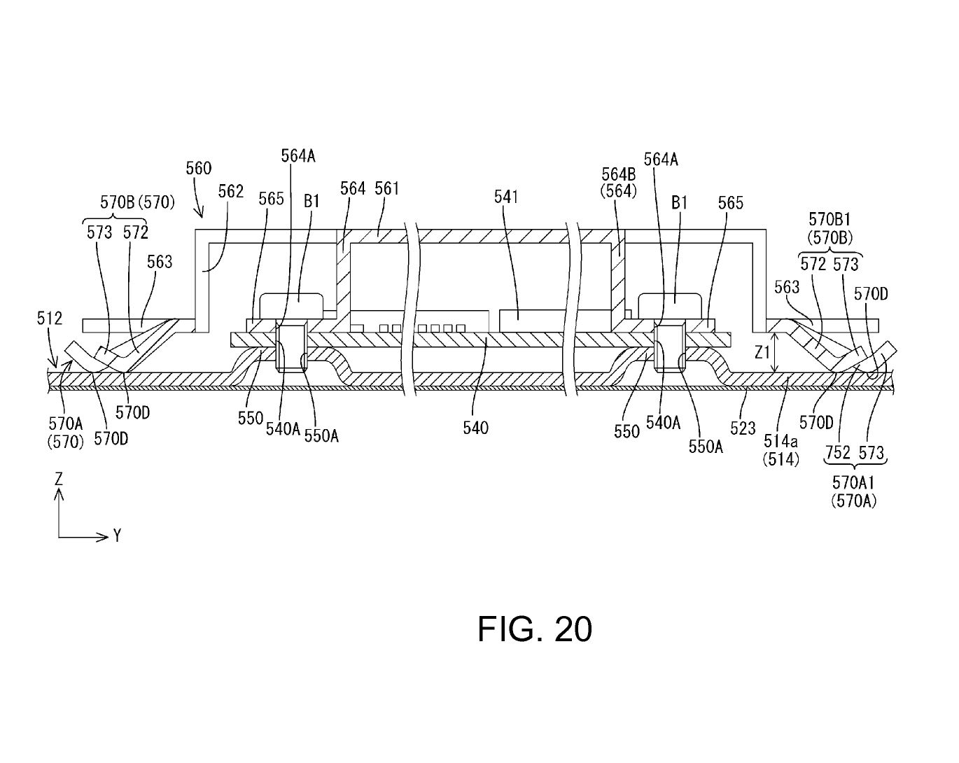

As shown in FIGS. 14 and 20, a light reflective sheet 523 is disposed on the inner surface side of the bottom plate 514a of the chassis 514 (on the surface side facing the cold cathode tubes 517). The light reflective sheet 523 is made of a synthetic resin and has a surface that is a highly reflective white. The light reflective sheet 523 is laid covering almost the entire bottom plate 514a of the chassis 514 along the inner surface thereof. With the light reflective sheet 523, it is possible to reflect light emitted from the cold cathode tubes 517 towards the diffusion plate 515a. The light reflective sheet is not shown in FIGS. 15, 22, and 24.

On the other hand, the diffusion plate 515a and the optical sheets 515b are disposed at the opening 514b of the chassis 514. The diffusion plate 515a made by dispersing light diffusing particles in the synthetic resin plate-shaped member, and has the function of diffusing linear light emitted from the cold cathode tubes 517, which are line-shaped light sources. The shorter side edges of the diffusion plate 515a are disposed on first surfaces 520a of holders 520 as described above, and are not restrained in the up and down direction. On the other hand, the longer side edges of the diffusion plate 515a are fixed in place by being sandwiched between the chassis 514 and the frames 516.

The optical sheets 515b disposed on the diffusion plate 515a include a diffusion sheet, a lens sheet, and a reflective polarizing plate layered in that order from the diffusion plate 515a, and have the function of converting light emitted from the cold cathode tubes 517 and passing through the diffusion plate 515a into planar light. The liquid crystal panel 511 is disposed over the optical sheets 515b, and the optical sheets 515b are sandwiched between the diffusion plate 515a and the liquid crystal panel 511.

The cold cathode tubes 517 are narrow tubes disposed such that the lengthwise direction (axis direction) thereof matches the longer side direction of the chassis 514, with the plurality of cold cathode tubes 517 (20 in the present embodiment) being stored in the chassis 514 parallel to each other (refer to FIG. 14). Terminals (not shown in drawings) that receive drive power are provided on the respective ends of the cold cathode tubes 517, the terminals are inserted inside the relay connectors 519, and the holders 520 are attached covering the relay connectors 519.

The holders 520 that cover the ends of the cold cathode tubes 517 are made of a white synthetic resin, and have a narrow substantially box shape that extends along the shorter side direction of the chassis 514. The holders 520 are disposed partially overlapping the shorter side outer edges 521a of the chassis 514, and constitute the side walls of the backlight device 512 along with the shorter side outer edges 521a. As shown in FIG. 15, insertion pins 524 protrude from a surface of the holders 520 facing the folded over outer edges 521a of the chassis 514, and as a result of the insertion pins 524 being inserted into insertion holes 525 formed in the upper surface of the shorter side outer edges 521a of the chassis 514, the holders 520 are attached to the chassis 514.

As shown in FIG. 15, the step-shaped surfaces of the holders 520 include three surfaces parallel to the bottom plate 514a of the chassis 514, and the shorter side edges of the diffusion plate 515a are placed on the first surfaces 520a, which are at the lowest position. In addition, inclined covers 526 that are inclined towards the bottom plate 514a of the chassis 514 extend from the first surfaces 520a. On the second surfaces 520b of the step-shaped surfaces of the holders 520, the shorter side edges of the liquid crystal panel 511 are placed. The third surfaces 520c of the step-shaped surfaces of the holder 520 are at the highest position, are disposed in positions overlapping the shorter side outer edges 521a of the chassis 514, and are in contact with the bezel 513.

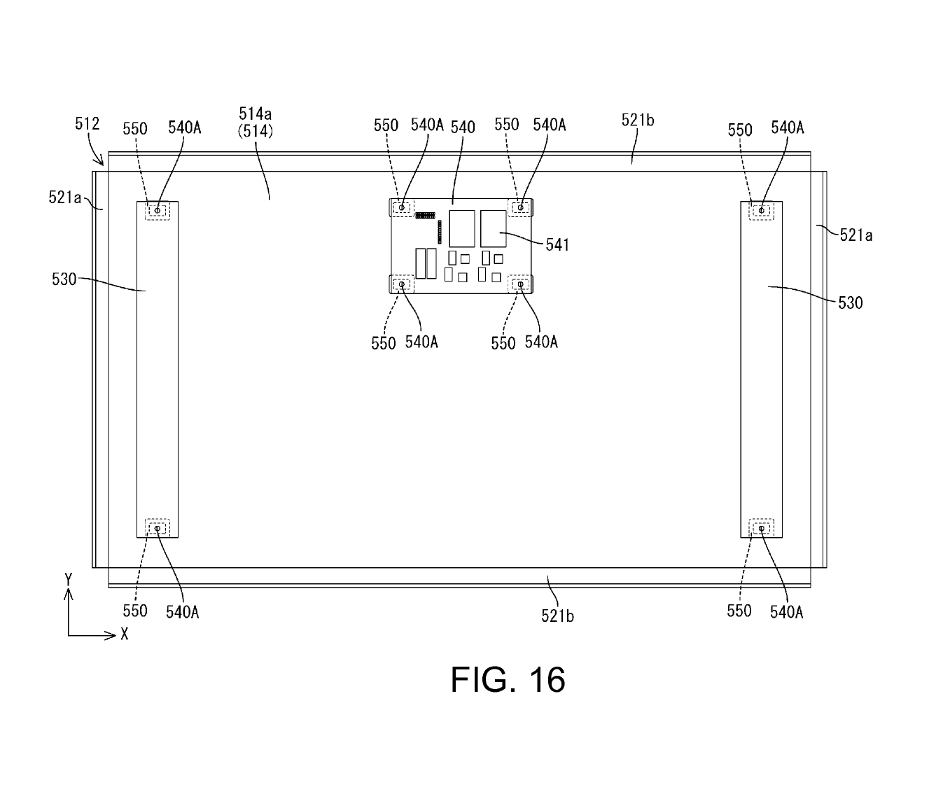

As shown in FIGS. 14 and 16, inverter substrates 530 and a control substrate 540 are attached to the outer side (side opposite to the cold cathode tubes 517; rear side) of the bottom plate 514a of the chassis 514. The above-mentioned power source substrate P (refer to FIG. 13; not shown in FIG. 16) is electrically connected to the inverter substrates 530, the control substrate 540, and the like, and is an electrical power source that supplies electrical power thereto.

As shown in FIG. 16, the inverter substrates 530 are respectively provided on both edges of the chassis 514, aligned in the longer side direction thereof, and have rectangular shapes that extend along the shorter side direction of the chassis 514. Each inverter substrate 530 is electrically connected to the cold cathode tubes 517 through connectors 527 and harnesses 528. The inverter substrates 530 have the function of switching the cold cathode tubes 517 on (or off) by increasing the voltage inputted from the power source substrate P using inverter circuits constituted of transformers and the like, outputting the voltage, which is higher than the voltage inputted from the power source substrate P, to the cold cathode tubes 517, and the like.

As shown in FIG. 16, the control substrate 540 (circuit board) has a rectangular shape that is long in the longer side direction (X axis direction) of the chassis 514 in a plan view. The control substrate 540 is disposed in the center of the longer side direction of the chassis 514 and towards one side of the shorter side direction (upper side of FIG. 16) of the chassis 514.

In the control substrate 540, circuit parts 541 are installed on a substrate made of a synthetic resin (such as phenolic paper or a glass epoxy resin, for example), and the control substrate 540 has a function of converting various input signals such as television signals from the tuner T to signals to drive the liquid crystal, and supplying these converted signals for driving the liquid crystal to the liquid crystal panel 511.

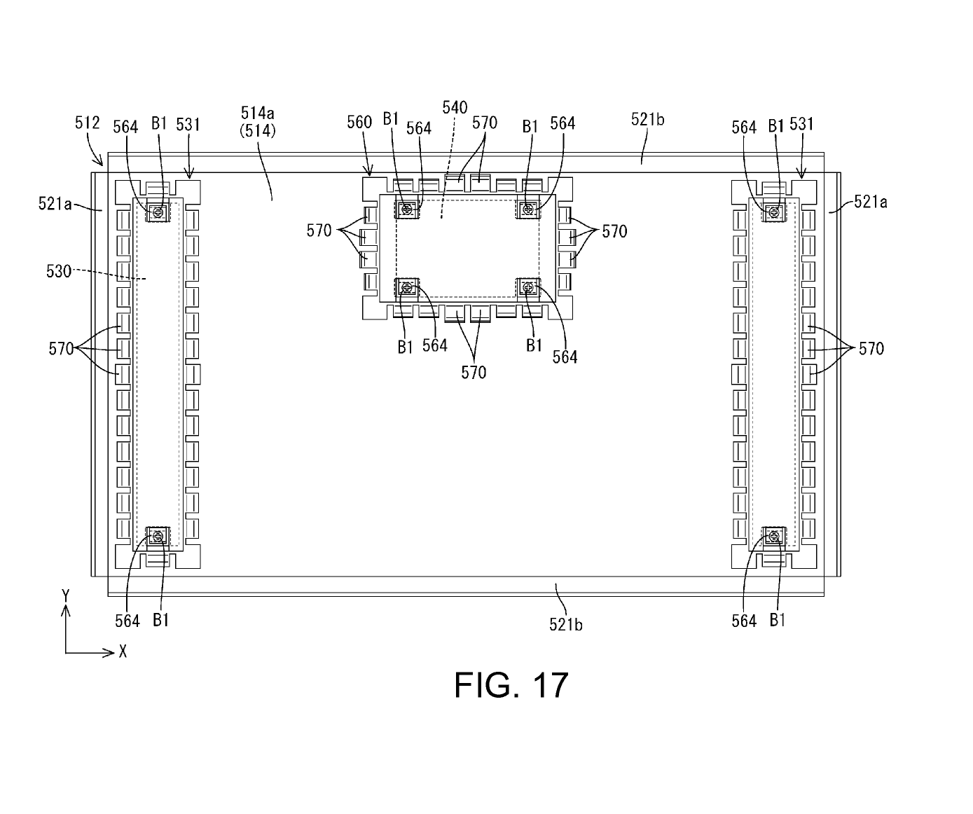

As shown in FIGS. 17 and 20, a substrate cover 560 is attached to the bottom plate 514a of the chassis 514 so as to cover the control substrate 540. Also, as shown in FIG. 17, substrate covers 531 covering the respective inverter substrates 530 are attached to the bottom plate 514a of the chassis 514. FIGS. 15 and 16 show a state in which the substrate covers 560 and 531 are removed. Such substrate covers 560 and 531 are designed to protect the substrates 540 and 530, and also have a function of preventing a hand or the like from coming into contact with the substrates when the substrates become hot during substrate driving, for example.

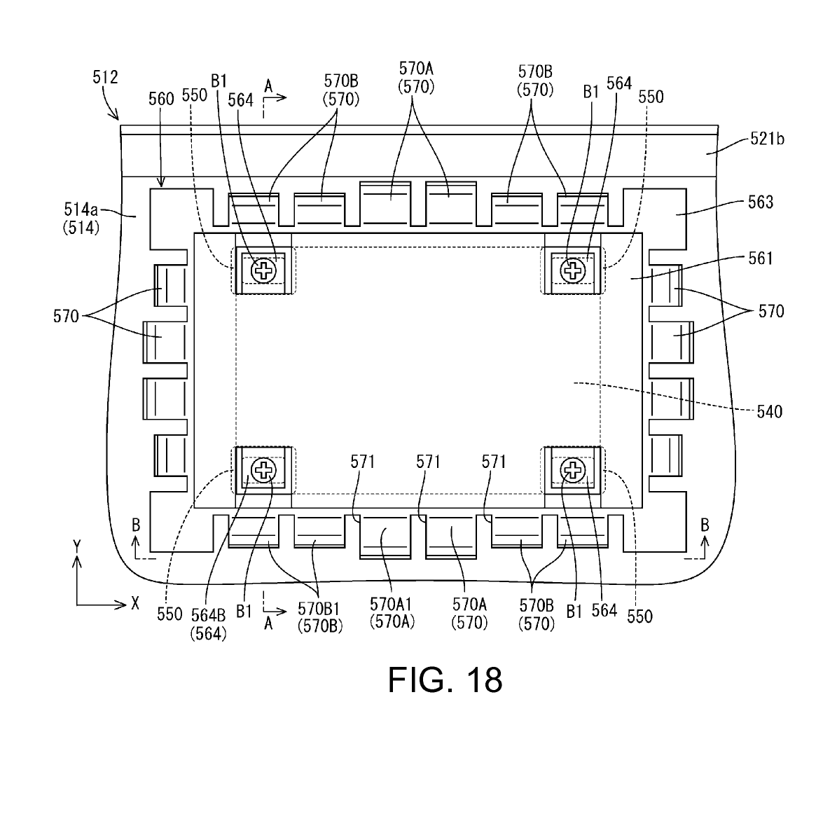

Next, the configuration of the substrate cover 560 will be described with reference to FIGS. 17 to 25. As shown in FIG. 18, the substrate cover 560 has a rectangular shape in a plan view, and is constituted a plate-shaped conductive material (a metal, for example) that is formed by sheet metal-forming.

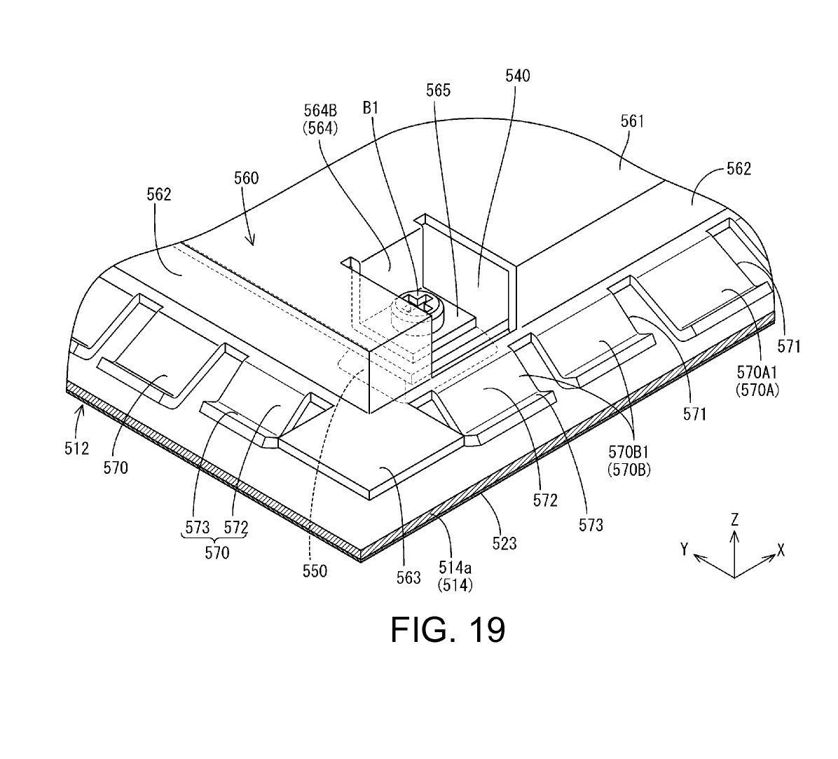

The substrate cover 560 has a substantially box shape that is open on the side facing the chassis 514, and, as shown in FIGS. 19 and 20, has a main wall 561 disposed such that the control substrate 540 is sandwiched between the chassis 514 and the main wall 561, four side walls 562 that respectively rise from the four peripheral edges of the main wall 561 towards the chassis 514, and a peripheral section 563 that extends from the ends of the respective side walls 562.

As shown in FIG. 18, the main wall 561 of the substrate 560 is a rectangle slightly larger than the control substrate 540 (shown with the dotted line in FIG. 18), and covers the control substrate 540 in a plan view. As shown in FIG. 20, in the substrate cover 560, the main wall 561 and the peripheral section 563 extend along the extension direction of the control substrate 540 and the bottom plate 514a of the chassis 514. In other words, the main wall 561 and the peripheral section 563 are disposed opposite to the bottom plate 514a of the chassis 514, and parallel thereto.

As shown in FIG. 20, the control substrate 540 and the substrate cover 560 are attached to attaching platforms 550 formed on the bottom plate 514a of the chassis 514 with screws B1. The attaching platforms 550 are respectively formed in positions corresponding to the four corners of the substrate cover 560 (and the control substrate 540) on an outer side chassis surface at the bottom plate 514a of the chassis 514.

As shown in FIGS. 18 and 19, the attaching platforms 550 have a rectangular shape in a plan view, and are formed by having a portion of the bottom plate 514a protrude toward the outer surface side of the chassis (rear side; upper side of FIG. 20). The substrate cover 560 (and the control substrate 540) is disposed covering the plurality of attaching platforms 550.

The substrate covers 531 covering the inverter substrates 530 are also attached to the chassis 514 with a configuration similar to the substrate cover 560. In other words, the attaching platforms 550 are respectively provided in positions on the bottom plate 514a of the chassis 514 corresponding to the respective ends of the longer side direction of the inverter substrates 530, and the inverter substrates 530 and the substrate covers 531 are attached by screws B 1.

As shown in FIG. 19, portions of the main wall 561 of the substrate cover 560 corresponding in position to the respective attaching platforms 550 are punched through and bent towards the attaching platforms 550, thus forming attaching parts 564. As shown in FIG. 20, the attaching parts 564 are bent in a substantially L shape, and the tips 565 thereof extend along the extension direction of the control substrate 540.

As shown in FIG. 20, the tips 565 of the attaching parts 564 are respectively penetrated by insertion holes 564A through which screws B1 can be respectively inserted. Insertion holes 540A through which the screws B1 can be inserted are formed through the control substrate 540 so as to match in position with the insertion holes 564A. The attaching platforms 550 of the chassis 514 have attaching holes 550A, the inner surfaces thereof having threading for screws. The screws B1 are inserted into both the insertion holes 564A of the substrate cover 560 and the insertion holes 540A of the control substrate 540, and then the tips of the screws B1 are screwed into the attaching holes 550A, thereby attaching the control substrate 540 and the substrate cover 560 to the chassis 514.

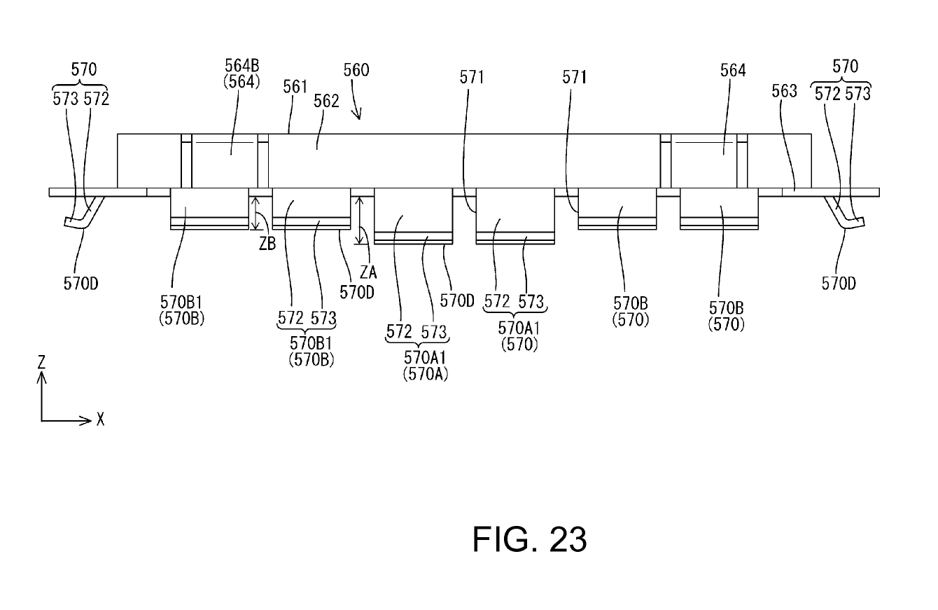

The peripheral section 563 of the substrate cover 560 is provided with a plurality of contact pieces 570 in contact with the chassis 514. As shown in FIGS. 19 and 23, the contact pieces 570 are formed extending towards the chassis 514 from the side walls 562. As shown in FIG. 18, the plurality of contact pieces 570 are disposed in a row along the entire peripheral section 563 on the four peripheral sides of the substrate cover 560. In order to form each contact piece 570, a plurality of cut out portions 571 are formed in the peripheral section 563 of the substrate cover 560, and then, a portion of the peripheral section 563 is bent towards the chassis 514 so as to be inclined, for example.

A base 572 of the contact piece 570 is inclined with respect to the extension direction (X axis or Y axis) of the peripheral section 563 and extends towards the bottom plate 514a. The tip 573 of the contact piece 570 is bent from the base 572 in a direction opposite to the bottom plate 514a, and the surface of the bent portion on the side of the bottom plate 514a (contact surface 570D) is in contact with the bottom plate 514a of the chassis 514. In other words, in the contact piece 570, the contact surface 570D in contact with the bottom plate 514a of the chassis 514 has a bent surface with a bend protruding towards the chassis 514. By giving the contact surface 570D in contact with the chassis 514 a bent surface with a bend protruding towards the chassis 514, the contact piece 570 is deformable with greater ease by being pressed against the bottom plate 514a of the chassis 514 when the contact surface 570D is brought into contact with the chassis 514. As a result, the contact surface 570D is in closer contact with the bottom plate 514a of the chassis 514, allowing the chassis 514 and the contact surface 570D to be more reliably in contact. As a result, it is possible to mitigate vibration in the contact pieces 570 when the backlight device 512 is being driven, which allows unwanted noises to be mitigated.

As shown in FIG. 20, the contact pieces 570 have a plate shape and are in contact with the bottom plate 514a of the chassis 514 while warping in the plate thickness direction. With this configuration, the contact surface 570D of the contact piece 570 is in contact with the bottom plate 514a of the chassis 514 with a certain amount of contact pressure, which allows the contact piece 570 to be more reliably in contact with the bottom plate 514a. “In contact while warping” refers to the fact that the contact pieces 570 are in contact with the bottom plate 514a while being elastically deformed towards a side opposite to the chassis 514 in the plate thickness direction.

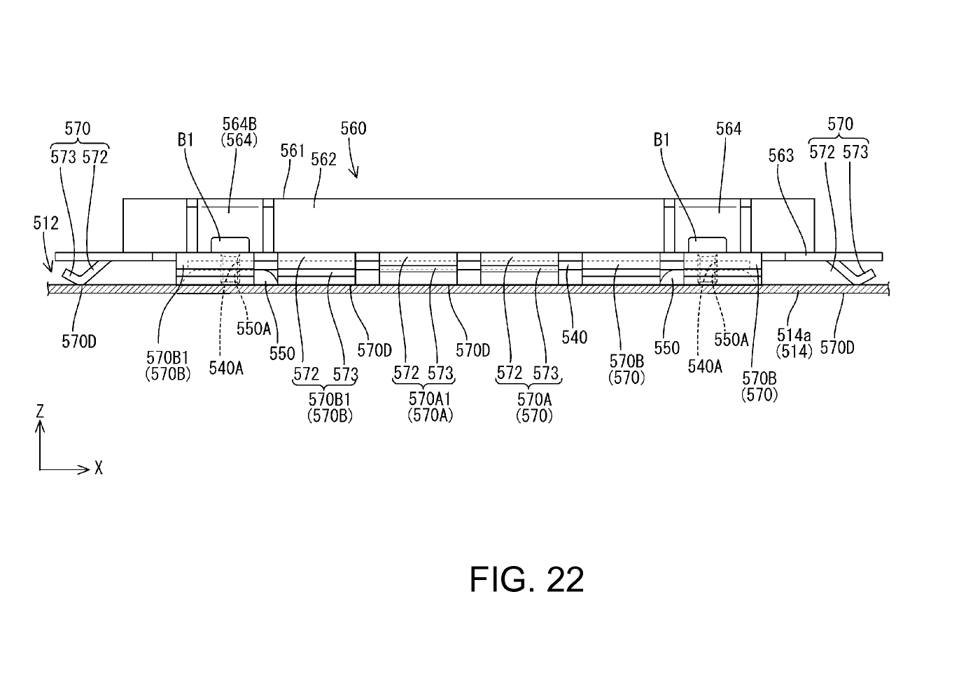

Of the peripheral section 563 of the substrate cover 560, both edges aligned in the shorter side direction (Y axis direction) have a plurality (six in the present embodiment) of contact pieces 570 disposed along the longer side direction (X axis direction). As shown in FIGS. 18 and 22, the plurality of contact pieces 570 disposed along the X axis direction all have the same plate width and plate thickness, for example.

Also, of the peripheral section 563 of the substrate cover 560, both edges aligned in the longer side direction (X axis direction) have a plurality (four in the present embodiment) of contact pieces 570 disposed along the shorter side direction (Y axis direction). As shown in FIG. 18, the plurality of contact pieces 570 disposed along the Y axis direction all have the same plate width and plate thickness, for example.

To describe the plurality of contact pieces 570 disposed along the X axis direction in further detail, if the two contact pieces 570 disposed in the center out of the plurality of contact pieces 570 disposed along the X axis direction are first contact pieces 570A, and the contact pieces 570 disposed towards the edges are second contact pieces 570B, then an extension length ZA from the substrate cover 560 at the first contact piece 570A is greater than an extension length ZB from the substrate cover 560 at the second contact piece 570B.

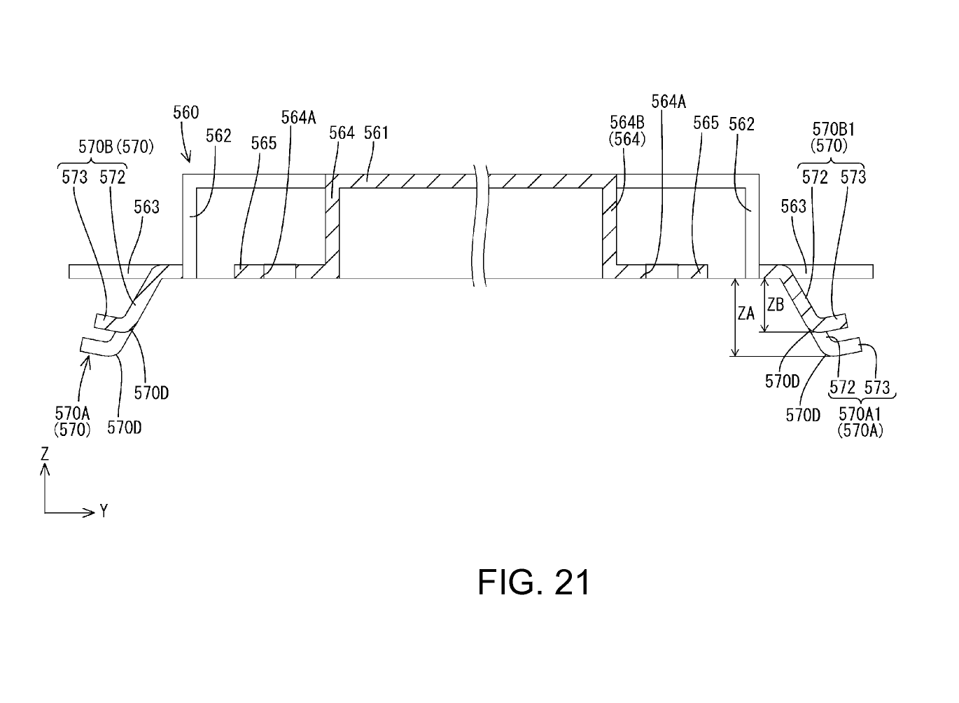

The extension length from the substrate cover 560 of the contact pieces 570 refers to the length in the Z axis direction (the direction from the contact piece 570 towards the bottom plate 514a) from the base of the contact pieces 570 to the contact surfaces 570D to be in contact with the chassis 514 in a state before the substrate cover 560 is attached to the chassis 514 as shown in FIG. 21 (in other words, a natural state in which no external force is acting upon the contact pieces 570), for example.

In other words, as shown in FIGS. 21 and 23, in a natural state (state in which no external force is applied on the contact pieces 570), the contact surface 570D of the first contact piece 570A (shown with reference character 570A1 in FIG. 21) is disposed further from the substrate cover 560 in the Z axis direction than the contact surface 570D of the second contact piece 570B (shown with reference character 570B1 in FIG. 21).

In the present embodiment, the first contact pieces 570A and the second contact pieces 570B have shapes that extend in the same direction (in other words, the angle of incline of the first contact piece 570A to the peripheral section 563 is the same as that of the second contact piece 570B) from the substrate cover 560 in the natural state shown in FIG. 21. Also, the total length of the first contact piece 570A is greater than the total length of the second contact piece 570B. In other words, the extension lengths ZA and ZB of the respective contact pieces 570A and 570B from the substrate cover 560 are respectively proportional to the total lengths of the respective contact pieces 570A and 570B.

The extension length ZA of the first contact piece 570A and the extension length ZB of the second contact piece 570B are set to be less than a gap Z1 (refer to FIG. 20) between the peripheral section 563 and the bottom plate 514a after the substrate cover 560 is attached to the chassis 514. As a result, in a state in which the substrate cover 560 is attached to the chassis 514, the first contact piece 570A and the second contact piece 570B are in contact with the bottom plate 514a while being warped.

The first contact pieces 570A and the second contact pieces 570B disposed along the longer side direction of the substrate cover 560 are in a positional relation in a plan view with the adjacent attaching parts 564 such that the first contact pieces 570A (reference character 570A1 in FIGS. 18 and 22, for example) are relatively far from the adjacent attaching part 564 (reference character 564B in FIG. 18, for example) of the substrate cover 560 and the second contact pieces 570B (reference character 570B1 in FIGS. 18 and 22, for example) are relatively close to the attaching part 564B of the substrate cover 560.

In other words, in the present embodiment, the first contact pieces 570A (first contact piece 570A1, for example) disposed relatively far from the attaching parts 564 (attaching part 564B, for example) have a greater extension length from the substrate cover 560 than the second contact pieces 570B (second contact pieces 570B 1, for example) disposed relatively close to the attaching parts 564 (attaching part 564B, for example).

The contact pieces 570 disposed along the shorter side direction (Y axis direction) of the substrate cover 560 have a similar configuration to the contact pieces 570 disposed along the longer side direction (X axis direction). In other words, the contact pieces 570 that are relatively far from the adjacent attaching parts 564 have a greater extension length than the contact pieces 570 that are relatively close to the attaching parts 564. Specifically, of the contact pieces 570 disposed along the Y axis direction, the extension length of the contact pieces 570 disposed in the center in the Y axis direction is the greatest.

As described above, the backlight device 512 of the present embodiment includes: a cold cathode tube 517; a chassis 514 that stores the cold cathode tube 517; a control substrate 540 attached to the chassis 514; and a substrate cover 560 attached to the chassis 514 and disposed so as to cover the control substrate 540, the substrate cover 560 and the chassis 514 being made of a conductive material, the substrate cover 560 having an attaching part 564 attached to the chassis 514, the substrate cover 560 being provided with a plurality of contact pieces 570 extending towards the chassis 514 and in contact therewith, the plurality of contact pieces 570 having a plate shape and being in contact with the chassis 514 while warping in the plate thickness direction, first contact pieces 570A having a greater extension length from the substrate cover 560 than second contact pieces 570B where, of the plurality of contact pieces 570, the contact pieces 570 disposed in a position relatively far from the attaching part 564 of the substrate cover 560 are the first contact pieces 570A, and the contact pieces 570 disposed relatively close to the attaching part 564 of the substrate cover 560 are the second contact pieces 570B.

In the present embodiment, the substrate cover 560 and the chassis 514 are made of a conductive material, and thus, by having the contact pieces 570 extending from the substrate cover 560 be in contact with the chassis 514, the substrate cover 560 and the chassis 514 are electrically connected. With this configuration, when driving the control substrate 540, even if electromagnetic waves are emitted from the control substrate 540, the substrate cover 560 and the chassis 514 effectively shield the control substrate 540 so as to prevent electromagnetic waves from leaking out, and thus, it is possible to mitigate the emission of electromagnetic waves to the outside. It is possible to electrically connect the substrate cover 560 to the chassis 514 by using a simple configuration in which the contact pieces 570 extend from the substrate cover 560, and thus, it is possible to improve assembly productivity compared to a case in which a conductive member such as a gasket is used.

If the contact pieces 570 are in contact (elastically) with the chassis 514 (bottom plate 514a) while being warped, the bottom plate 514a receives pressure from the contact pieces 570 in the form of elastic force (restoring force), which results in cases in which the bottom plate 514a is pushed away from the substrate cover 560. In the configuration of the present embodiment, the attaching parts 564 of the substrate cover 560 are attached to the bottom plate 514a.

If the contact pieces 570 press down on the bottom plate 514a and the bottom plate 514a warps further away from the substrate cover 560, then positions on the bottom plate 514a further away from the attaching parts 564 (where the chassis 514 and the substrate cover 560 are attached) of the substrate cover 560 are more susceptible to warping, and the amount of warping has a tendency to be greater in those positions. As a result, in the chassis 514, the contact pressure on the bottom plate 514a from the contact pieces 570 becomes small in positions far from the attaching parts 564 of the substrate cover 560 (the midway position between two attaching parts 564 disposed in the X axis direction, for example), which results in the risk that the contact becomes insufficient. In particular, if the warping of the bottom plate 514a is especially large, there is a risk that the bottom plate 514a and the contact pieces 570 would no longer be in contact.

In the present embodiment, of the plurality of contact pieces 570, the extension length ZA of the first contact pieces 570A disposed relatively far from the attaching parts 564 (attaching positions) is greater than the extension length ZB of the second contact pieces 570B disposed relatively close to the attaching parts 564. With this configuration, even if positions in the bottom plate 514a relatively far from the attaching parts 564 (positions susceptible to warping) were to warp, it is possible to reliably connect the first contact pieces 570A to the bottom plate 514a. Thus, the substrate cover 560 can be more reliably connected electrically to the chassis 514, which allows the electromagnetic shield effect to be greater.

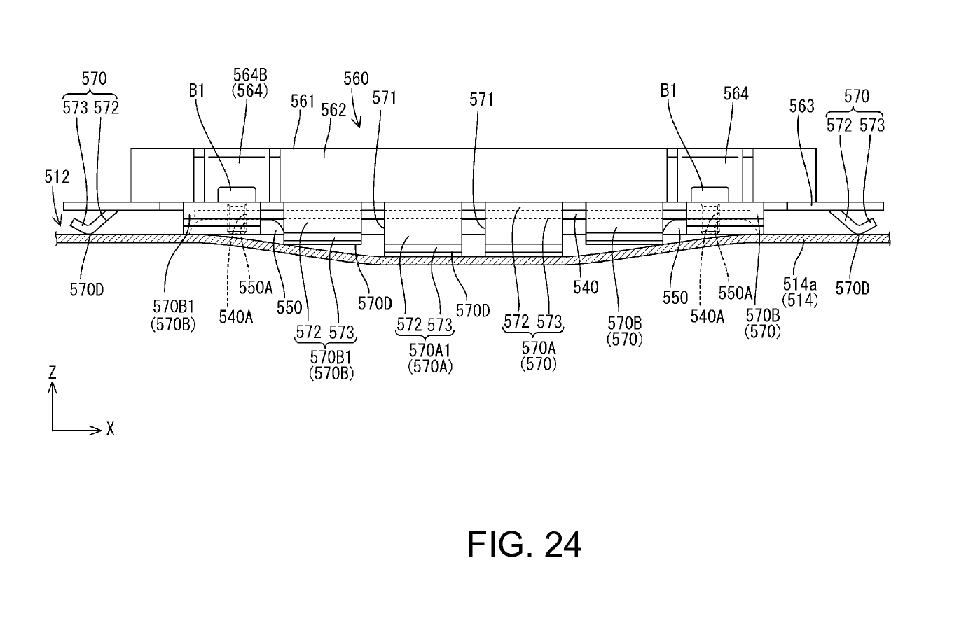

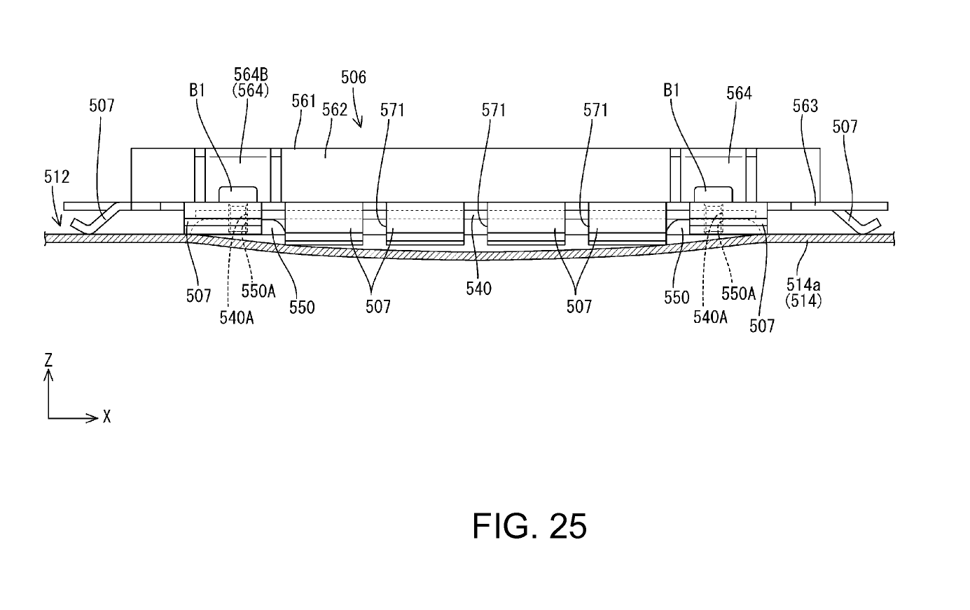

Next, effects achieved by having the extension length ZA of the first contact pieces 570A be larger than the extension length ZB of the second contact pieces 570B will be described in detail with reference to FIGS. 24 and 25. FIG. 24 shows a state in which the bottom plate 514a of the chassis 514 is warped in the configuration of the present embodiment. FIG. 25 shows a substrate cover 506 of a comparison example. In the substrate cover 506, all of the plurality of contact pieces 507 disposed along the X axis direction have the same extension length. In FIG. 25, parts that are the same as those of the present embodiment are assigned the same reference characters.

As shown in FIG. 25, if the bottom plate 514a warps, the bottom plate 514a is susceptible to a large amount of deformation in the midway position (position in the bottom plate 514a that are far from the attaching parts 564 and susceptible to warping) between two attaching parts 564 disposed in the X axis direction, for example. As a result, if all contact pieces 507 have the same extension length, then as shown in FIG. 25, there is a possibility that the contact surfaces of the contact pieces 507 do not reach the bottom plate 514a in the midway position between the two attaching parts 564 and that the contact pieces 507 do not make contact with the bottom plate 514a (the contact pieces 507 in the center in the left and right direction in FIG. 25).

As a countermeasure, in the present embodiment, the extension length ZA of the first contact pieces 570A is greater than the extension length ZB of the second contact pieces 570B. Thus, as shown in FIG. 24, even if the bottom plate 514a were to warp, it is possible to have a reliable connection between the first contact pieces 570A and the bottom plate 514a in positions far from the attaching parts 564.

In other words, compared to the comparison example, it is possible to have more contact positions between the bottom plate 514a and the substrate cover 560, and it is possible to more reliably connect electrically the bottom plate 514a and the substrate cover 560. The warping in the chassis 514 shown in FIGS. 24 and 25 is to describe the effects of the present embodiment, and the warping state (such as the amount of warping) is not limited to what is shown in FIGS. 24 and 25.

As shown in FIGS. 20 and 22, in a case in which the bottom plate 514a of the chassis 514 is not warped, by having the first contact pieces 570A and the second contact pieces 570B warp, the respective contact surfaces 570D of the first contact pieces 570A and the second contact pieces 570B are disposed in the same position in the Z axis direction.

The plurality of contact pieces 570 are disposed along the entire peripheral section 563 of the substrate cover 560.

By having the plurality of contact pieces 570 disposed around the entire substrate cover 560, when the contact pieces 570 are in contact with the chassis 514 while warping, the elastic force of the respective contact pieces 570 is well-balanced around the entire substrate cover 560. As a result, the contact pressure of the respective contact pieces 570 on the chassis 514 can be made more even. Thus, the contact pieces 570 can be more reliably in contact with the chassis 514.

The substrate cover 560 has the main wall 561 disposed such that the control substrate 540 is sandwiched between the main wall 561 and the chassis 514, and side walls 562 that rise from the peripheral edges of the main wall 561 towards the chassis 514, and the plurality of contact pieces 570 extend from the side walls 562.

If the contact pieces 570 are configured so as to extend from the side walls 562, compared to a case in which the contact pieces 570 extend from the main wall 561, for example, the extension length of the contact pieces 570 can be made shorter. As a result, it is possible to reduce the cost of forming the contact pieces 570.

### Embodiment 5

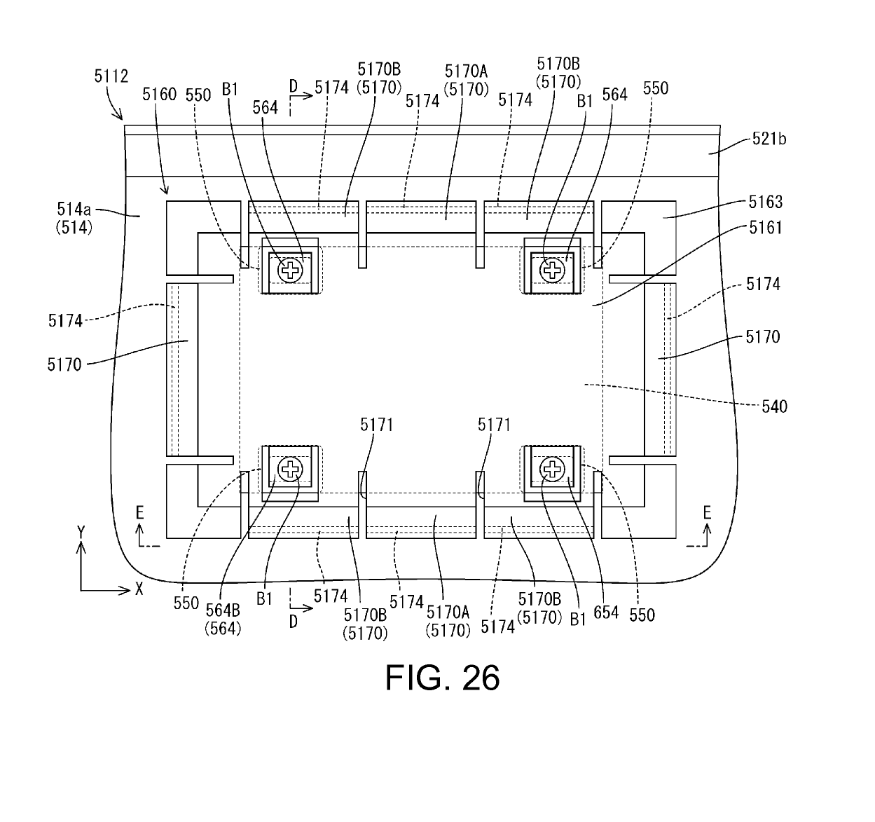

Next, Embodiment 5 of the present invention will be described with reference to FIGS. 26 to 29. Parts that are the same as those in the embodiments above are assigned the same reference characters, and redundant descriptions thereof will be omitted. In a backlight device 5112 of the present embodiment, contact pieces in the substrate cover have a different configuration from those of the previous embodiments.

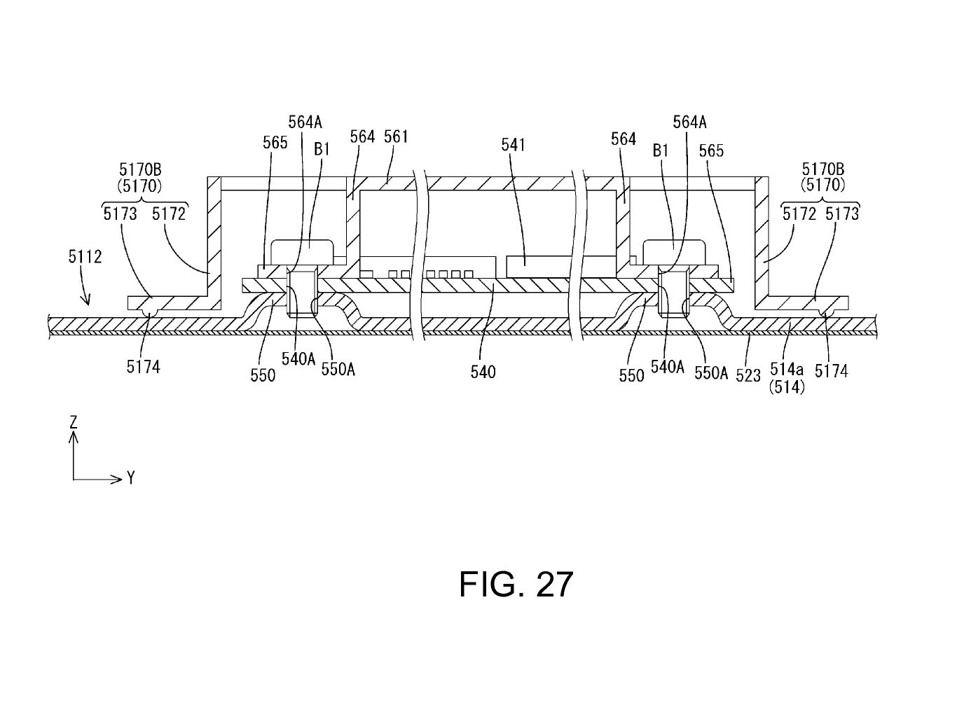

As shown in FIGS. 26 and 27, contact pieces 5170 of the present embodiment extend from a main wall 5161 of a substrate cover 5160. More specifically, the respective contact pieces 5170 are elastically deformable portions of the substrate cover 5160 made by forming a plurality of cut out portions 5171 across a peripheral section 5163 from the main wall 5161. In other words, the contact pieces 5170 constitute a portion of the side walls 5162 and a portion of the peripheral section 5163 in the substrate cover 5160.

As shown in FIG. 27, tips 5173 of the contact pieces 5170 of the present embodiment are bent in a substantially right angle to a base 5172, and run substantially parallel to a bottom plate 514a of a chassis 514. Protrusions 5174 that protrude towards the bottom plate 514a are formed on a surface of the tips 5173 facing the bottom plate 514a.

As shown in FIG. 26, the protrusion 5174 is formed extending along the plate width direction of the contact piece 5170. The protruding end of the protrusion 5174 is in contact with the bottom plate 514a of the chassis 514, thereby electrically connecting the substrate cover 560 to the chassis 514. In a state in which the respective protrusions 5174 are in contact with the bottom plate 514a, the contact pieces 5170 warp in a direction further from the bottom plate 514a (plate thickness direction).

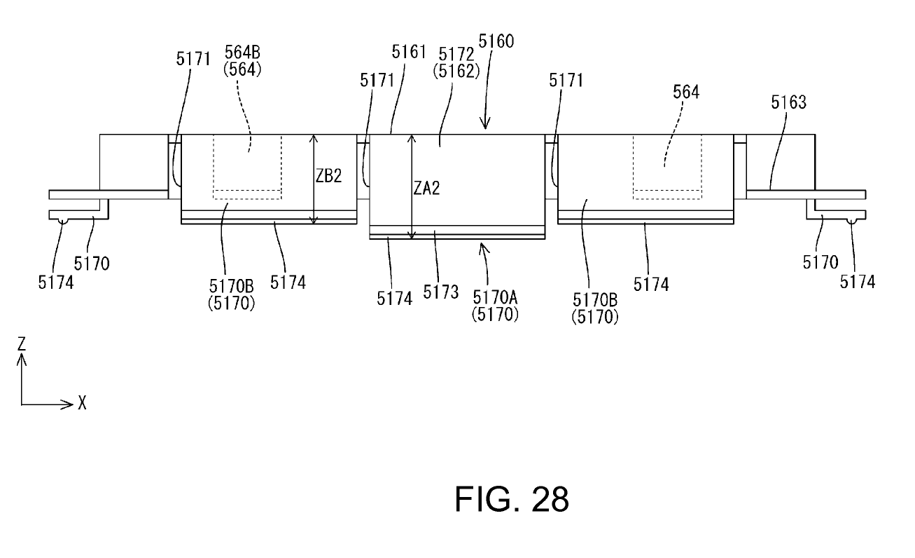

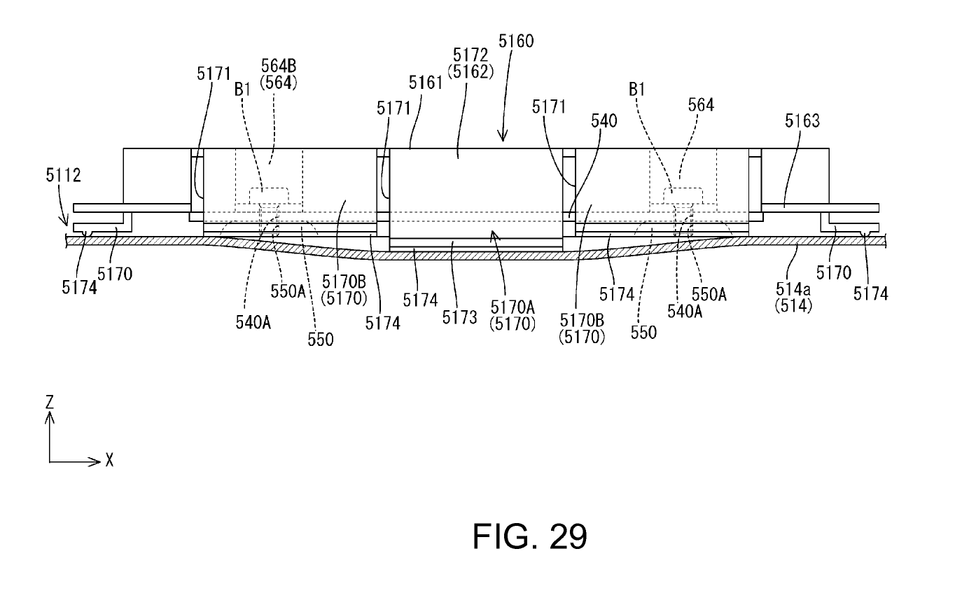

In the present embodiment also, among contact pieces 5170 in a natural state (a state in which the substrate cover 5160 is not attached to the chassis 514; refer to FIG. 28), an extension length ZA2 (length in the Z axis direction) of first contact pieces 5170A disposed relatively far from the attaching parts 564 (attaching part 564B, for example) is greater than an extension length ZB2 of second contact pieces 5170B, similar to the previous embodiment (refer to FIG. 28). As shown in FIG. 29, with this configuration, even if the bottom plate 514a of the chassis 514 were to warp, it is possible to have a more reliable contact between protrusions 5174 of the contact pieces 5170A, which are in the midway position between the two attaching parts 564 (position in the bottom plate 514a susceptible to warping), and the bottom plate 514a.

The contact pieces 5170 of the present embodiment are in contact with the chassis 514 while warping in the plate thickness direction, and therefore, it is preferable that a certain amount of warping occur. If the contact pieces 5170 extend from the main wall 5161 as in the present embodiment, compared to a configuration (configuration of Embodiment 4, for example) in which the contact pieces 5170 extend from the side walls 5162, for example, the total length of each contact piece 5170 becomes greater, which means that the contact pieces 5170 can be made more susceptible to warping in the plate thickness direction. As a result, it is possible to form contact pieces 5170 susceptible to warping with ease.

In the present embodiment, the contact pieces 5170 are formed by cutting out portions of the substrate cover 5160. It is preferable that the number of cut out portions 5171 (and by extension the total area thereof) be as small as possible in order to increase the shielding effect of the substrate cover 5160 against electromagnetic waves. However, if the number of cut out portions 5171 is reduced (in other words, if the number of contact pieces 5170 is reduced), the plate width of each contact piece 5170 increases. As a result, the contact pieces 5170 are less susceptible to warping, making it difficult to be in contact with the chassis 514 while warping.

In the present embodiment, the contact pieces 5170 extend from the main wall 5161, and thus, the total length of the contact pieces 5170 is increased, thus making the contact pieces 5170 more susceptible to warping. As a result, even if the number of cut out portions 5171 is reduced, and therefore, the plate width of each contact piece 5170 is increased, the contact pieces 5170 are susceptible to warping.

In the present embodiment, protrusions 5174 that protrude towards the chassis 514 are formed on the tips of the plurality of contact pieces 5170, and the protrusions 5174 are in contact with the chassis 514.

In the present embodiment, the protrusions 5174 in the contact pieces 5170 are in contact with the bottom plate 514a of the chassis 514. With this configuration, it is possible to adjust the contact pressure on the bottom plate 514a of the chassis 514 with ease by adjusting the height of the protrusions 5174 when forming the protrusions 5174.

### Embodiment 6

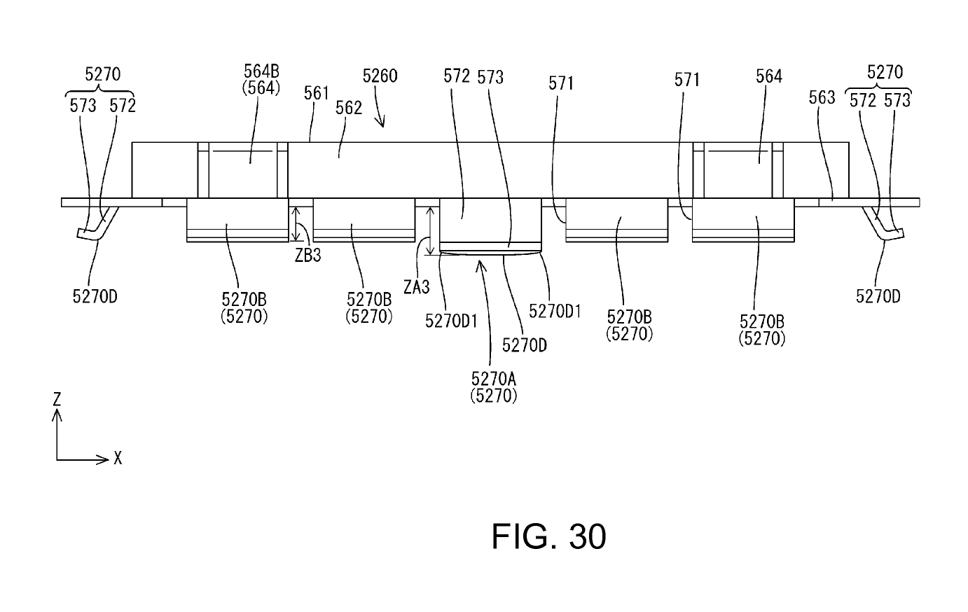

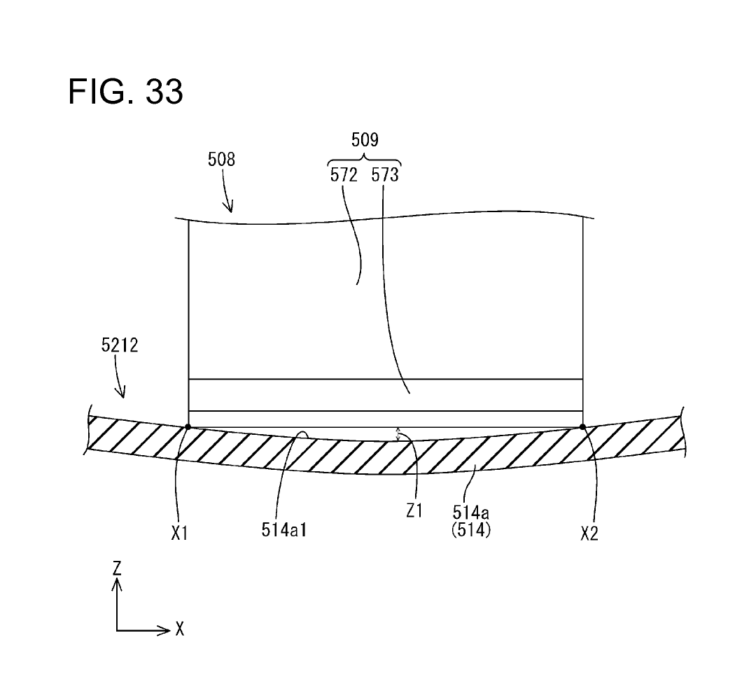

Next, Embodiment 6 of the present invention will be described with reference to FIGS. 30 to 33. Parts that are the same as those in the embodiments above are assigned the same reference characters, and redundant descriptions thereof will be omitted. FIG. 33 shows a comparison example for comparison with the present embodiment. In a backlight device 5212 of the present embodiment, contact pieces in the substrate cover have a different configuration from those of the previous embodiments.

As shown in FIG. 30, respective contact pieces 5270 of a substrate cover 5260 of the present embodiment are similar to the substrate cover 560 of Embodiment 4 in extending from the side walls 562. As in the above-mentioned contact pieces 570 and 5170, among the plurality of contact pieces 5270, an extension length ZA3 of first contact pieces 5270A in positions relatively far from attaching parts 564 (midway position between two attaching parts 564 disposed along the X axis direction, for example) is greater than an extension length ZB3 of second contact pieces 5270B in positions relatively close to the attaching parts 564.

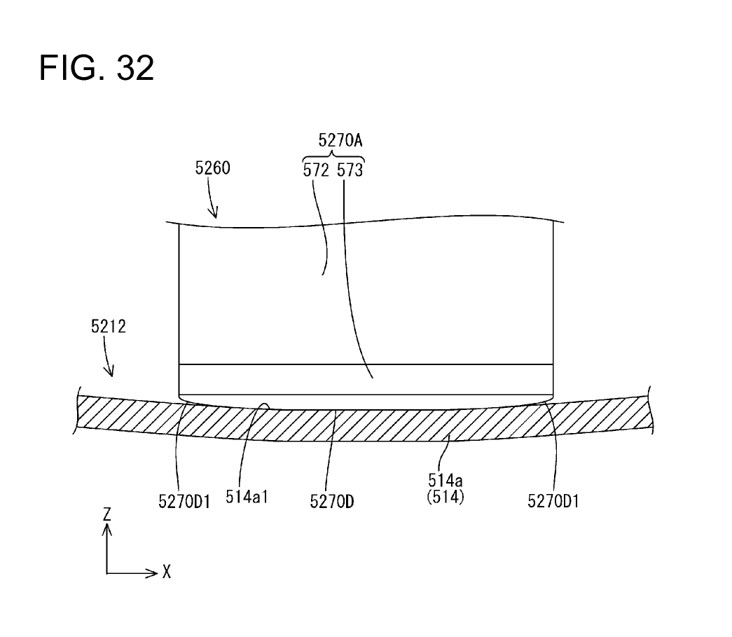

As shown in FIGS. 30 and 32, in the first contact pieces 5270A, each end surface 5270D1 (ends towards the attaching parts 564) in the X axis direction of the contact surface 5270D in contact with the chassis 514 has a fillet shape. More specifically, each end surface 5270D1 has a shape that curves towards the substrate cover 5260 the closer it is to the outside (towards the attaching parts 564).

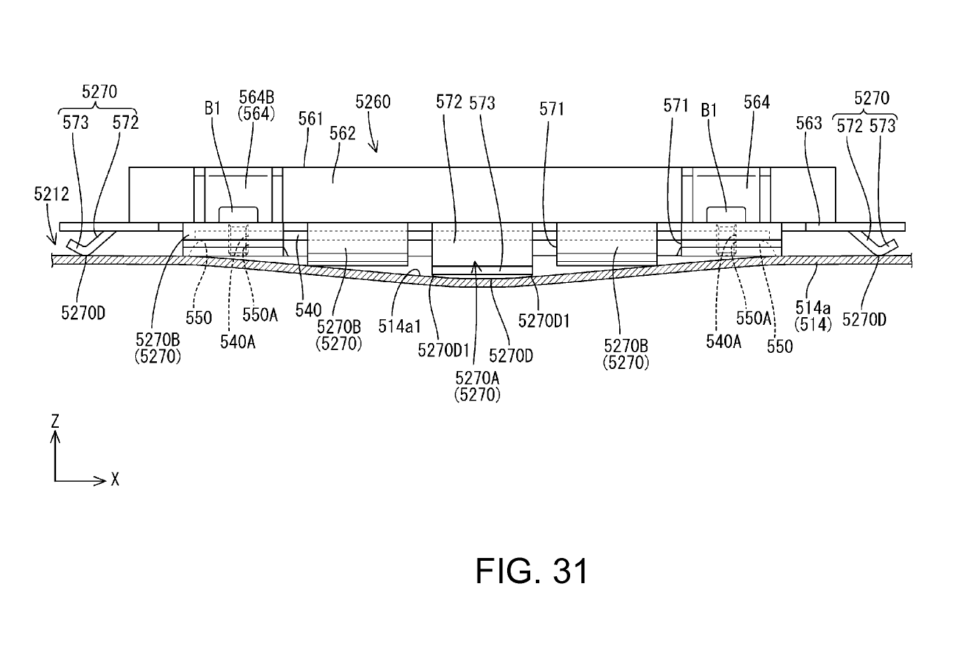

If the attaching parts 564 of the substrate cover 5260 are attached to the chassis 514 as in the present embodiment, then as shown in FIGS. 31 and 32, if the bottom plate 514a of the chassis 514 warps due to pressure from the respective contact pieces 5270, then a contacted surface 514a1 of the bottom plate 514a in contact with the contact pieces 5270 has a shape that curves towards the substrate cover 560 the closer it is to the attaching parts 564.

If, as shown in the comparison example of FIG. 33, each contact piece 509 of a substrate cover 508 has X axis direction edges with angular shapes in contact with a bottom plate 514a, then if the contacted surface 514a1 of the bottom plate 514a is warped in a curved shape, there is a possibility that the contact piece 509 is only in contact with two end positions (X1 and X2 in FIG. 33) on the contacted surface 514a1 in the X axis direction, and that a gap (arrow Z1 in FIG. 33) would be formed between X1 and X2.

If, as in the present embodiment, the ends (end surfaces 5270D1) on the sides of the contact pieces 5270 towards the attaching parts 564 are given a curved surface that approaches the substrate cover 560 the closer it is to the attaching parts 564, then as shown in FIG. 32, it is possible to have the warped contacted surface 514a1 be in closer contact with the first contact piece 5270A with ease, and it is possible to increase the contact area thereof. As a result, the first contact pieces 5270A can be more reliably in contact with the chassis 514.

In the present embodiment, a configuration was described as an example in which the first contact pieces 5270A have edges with a fillet shape towards the attaching parts 564, but the edge with a fillet shape can be applied to other contact pieces 5270. However, the first contact pieces 5270A are disposed in a position on the bottom plate 514a of the chassis 514 that is susceptible to warping (position where the contacted surface 514a1 is susceptible to warping). Thus, it is particularly effective to provide the edges of the first contact pieces 5270A corresponding to the positions susceptible to such warping with a fillet shape.

The following configurations can also be used for Embodiments 4 to 6.

(1) The number and position of contact pieces 570, 5170, and 5270 are not limited to the examples of the embodiments above, and may be modified as appropriate. Any configuration may be used as long as the substrate cover is provided with a plurality (at least two) contact pieces, and, of the plurality of contact pieces, the extension length of the first contact pieces in positions relatively far from the attaching parts is greater than the extension length of the second contact pieces in positions relatively close to the attaching parts. The number of attaching parts 564 is not limited to that of the embodiments above, and may be only one, for example. If a plurality of attaching parts are provided, then as described in the embodiments above, contact pieces that are far from any one of the attaching parts (attaching part 564B, for example) may be referred to as first contact pieces, and contact pieces that are relatively close may be referred to as second contact pieces.

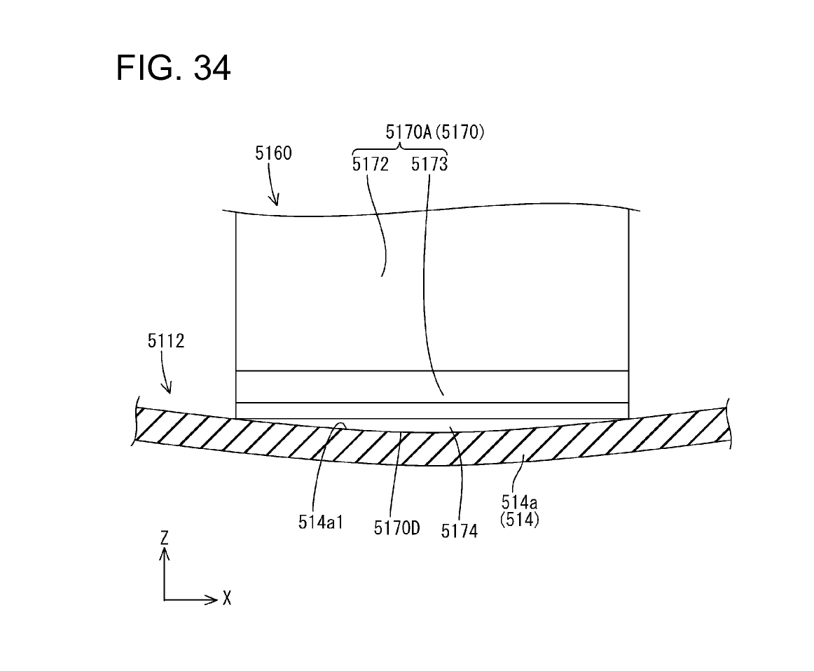

(2) In Embodiment 6, a configuration was described in which end surfaces 5270D1 on the sides of the contact piece 5270 towards the attaching parts 564 have a curved shape that approaches the substrate cover 560 the closer they are to the attaching parts 564, thus ensuring contact between the contact piece 5270 and the bottom plate 514a even if the bottom plate 514a is warped. Such a configuration in which the end surfaces have a curved surface that approaches the substrate cover 560 side the closer they are to the attaching part 564 may be applied to the protrusion 5174 of the contact piece 5170 described in Embodiment 5, for example. As shown in FIG. 34, for example, in the protrusion 5170, which is the portion in contact with the bottom plate 514a, the end surfaces (portions of the contact surface 5170D) towards the attaching parts 564 (left and right direction along the X axis direction of FIG. 34) may have a curved shape that approaches the substrate cover 560 side (upper side of FIG. 34) the closer it is to the attaching part 564.

(3) The material of the chassis 514 and the substrate cover 560 is not limited to a metal. The material for the chassis 514 and the substrate cover 560 can be appropriately modified as long as the material is conductive.

(4) The method of attaching the control substrate 540 and the substrate cover 560 to the chassis 514 is not limited to using the screws B1, and the method can be modified as appropriate. For example, a configuration may be used in which the control substrate 540 and the substrate cover 560 are attached to the chassis 514 using nuts, bolts, and the like. Alternatively, a configuration may be used in which the control substrate 540 and the substrate cover 560 are each attached separately to the chassis 514 by different attaching methods.

(5) The configuration of the attaching parts 564 of the substrate cover 560 is not limited to the examples of the embodiments above. The “attaching part” of the present invention refers to the portion of the substrate cover 560 attached to the chassis 514 (attaching position), and can be modified as appropriate based on the attaching method of the substrate cover 560 to the chassis 514.

(6) In the embodiments above, the control substrate 540 was given as an example of a circuit board, but the circuit board is not limited thereto. As long as the circuit board and the substrate cover can be attached to the chassis 514, the configuration of the present invention (a configuration in which the contact pieces are in contact with the chassis) can be applied.

(7) In the embodiments above, a case in which cold cathode tubes 517 are used as the light source was described, but the light source is not limited thereto. A hot cathode tube, an LED, or the like can also be used as the light source.

(8) In the embodiments above, the liquid crystal panel 511 and the chassis 514 are used in a vertical orientation such that the shorter side direction and the vertical direction match, but a case in which the liquid crystal panel 511 and the chassis 514 are used in a vertical orientation such that the longer side direction and the vertical direction match is also included in the present invention.

(9) In the embodiments above, TFTs are used as the switching elements in the liquid crystal display device 510, but the present invention can also be applied to a liquid crystal display device that uses switching elements other than TFTs (thin film diodes (TFD), for example), and, besides a color liquid crystal display device, the present invention can also be applied to a black and white liquid crystal display device.

(10) In the respective embodiments above, the liquid crystal display device 510 using the liquid crystal panel 511 as a display panel was described, but the present invention can also be applied to a display device that uses another type of display panel.

(11) In the respective embodiments above, the television receiver TV having a tuner was described, but the present invention can also be applied to a display device that does not have a tuner.

### DESCRIPTION OF REFERENCE CHARACTERS

10, 510 liquid crystal display device (display device)
11, 511 liquid crystal panel (display panel)
12, 112, 212, 512 backlight device (illumination device)
14, 514 chassis
17, 517 cold cathode tube (light source)
40, 540 control substrate (circuit board)
60, 160, 560 substrate cover
61, 161, 561 main wall
62, 162, 562 side wall
63, 163, 563 peripheral section of substrate cover
64, 564 attaching part
70, 170, 270, 570 contact piece
70A, 570A first contact piece
70B, 570B second contact piece
74, 5174 protrusion
270A, 570D contact surface (contact surface in contact with chassis)
TV television receiver

1. An illumination device, comprising:
a light source;
a chassis that stores the light source;
a circuit board attached to the chassis; and
a substrate cover attached to the chassis and disposed so as to cover the circuit board,
wherein the substrate cover and the chassis are made of a conductive material,
wherein the substrate cover has an attaching part attached to the chassis, and a plurality of contact pieces extending towards the chassis and in contact therewith,
wherein the plurality of contact pieces have a plate shape and are in contact with the chassis while warping in a plate thickness direction, and
wherein, where contact pieces disposed in a position relatively far from the attaching part of the substrate cover are first contact pieces among the plurality of contact pieces, and where contact pieces disposed relatively close to the attaching part of the substrate cover are second contact pieces among the plurality of contact pieces, the first contact pieces are more susceptible to warping in the plate thickness direction thereof than the second contact pieces.

2. The illumination device according to claim 1, wherein the plurality of contact pieces are disposed along an entire peripheral section of the substrate cover.

3. The illumination device according to claim 1,
wherein the substrate cover has a main wall disposed so as to sandwich the circuit board between the chassis and the main wall, and side walls that rise towards the chassis from a periphery of the main wall, and
wherein, of the plurality of contact pieces, at least one of the contact pieces extends from the main wall and constitutes a portion of the side walls.

4. The illumination device according to claim 1,
wherein the substrate cover has a main wall disposed so as to sandwich the circuit board between the chassis and the main wall, and side walls that rise towards the chassis from a periphery of the main wall, and
wherein, of the plurality of contact pieces, at least one of the contact pieces extends from one of the side walls.

5. The illumination device according to claim 1, wherein, of the plurality of contact pieces, at least one of the contact pieces has a contact surface in contact with the chassis having a bent shape with a bend that protrudes towards the chassis.

6. The illumination device according to claim 1,
wherein, of the plurality of contact pieces, a tip of at least one of the contact pieces has a protrusion that protrudes towards the chassis, and
wherein the protrusion is in contact with the chassis.

7. The illumination device according to claim 1, wherein an extension length from the substrate cover is greater for the first contact pieces than for the second contact pieces.

8. A display device, comprising:
the illumination device according to claim 1; and
a display panel that conducts display using light from the illumination device.

9. The display device according to claim 8, wherein the display panel is a liquid crystal panel using liquid crystal.

10. A television receiver, comprising the display device according to claim 8.
